(19) United States
(12) Patent Application Publication
(10) Pub. No.: US 2026/0225543 A1
(43) Pub. Date: Aug. 6, 2026

(54) COMMUNICATION SYSTEM, MANAGEMENT DEVICE, START-STOP CONTROL METHOD, AND STORAGE MEDIUM STORING CONTROL PROGRAM

(71) Applicant: DENSO CORPORATION, Kariya-city (JP)

(72) Inventors: Tomoya TOKUNAGA, Kariya-city (JP); Mana TANAKA, Kariya-city (JP)

(21) Appl. No.: 19/461,811

(22) Filed: Jan. 28, 2026

(30) Foreign Application Priority Data
Jan. 31, 2025 (JP) 2025-015093

(51) Int. Cl. B60R 16/023; G06F 1/3206

(52) U.S. Cl. CPC B60R 16/023; G06F 1/3206

(57) ABSTRACT

A communication system mounted on a mobile body includes a management device and an electronic control unit arranged to be capable of communication with the management device. The electronic control unit is activated by power supplied externally via a relay and stopped by power cutoff externally via the relay, and, in a state in which power is supplied, performs activation by switching to a wake-up state and stops by switching to a sleep state, based on a communication frame. The management device manages a scene relating to a behavior of the mobile body, and determines, when a request for activation or stop is received for the electronic control unit whether to perform a first start-stop control for the electronic control unit via the relay, and determines whether to perform a second start-stop control for the electronic control unit by switching to the wake-up state or the sleep state.

### CROSS REFERENCE TO RELATED APPLICATION

This application is based on Japanese Patent Application No. 2025-015093 filed on January 31, 2025, the disclosure of which is incorporated herein by reference.

### TECHNICAL FIELD

The present disclosure relates to a communication system, a management device, a start-stop control method for an electronic control unit, and a start-stop control program for an electronic control unit.

### BACKGROUND

In a vehicle, a large number of electronic control devices (also referred to as ECUs, Electronic Control Units) are installed to control onboard devices, and these ECUs are connected to a communication bus to construct a communication system. In this type of communication system, techniques are known for reducing overall system power consumption by transitioning unnecessary ECUs from a wake-up state to a sleep state. As a means for starting and stopping ECUs, for example, a related art discloses a configuration in which mechanical relay control is performed for each system.

### SUMMARY

According to an aspect of the present disclosure, a communication system mounted on a mobile body is provided. The communication system includes: a management device; and an electronic control unit arranged to be capable of communication with the management device. The electronic control unit may be activated by power supplied externally via a relay and stopped by power cutoff externally via the relay, and may be further configured to, in a state in which power is supplied, perform activation by switching to a wake-up state and stop by switching to a sleep state, based on a communication frame received externally. The management device may manage a scene relating to a behavior of the mobile body, and determine, when a request for activation or stop is received for the electronic control unit, based on the scene, whether to perform a first start-stop control for the electronic control unit via the relay, and determine whether to perform a second start-stop control for the electronic control unit by switching to the wake-up state or the sleep state.

### BRIEF DESCRIPTION OF DRAWINGS

Objects, features and advantages of the present disclosure will become more apparent from the following detailed description made with reference to the accompanying drawings. In the drawings:

FIG. 1 is a functional block diagram showing the overall configuration of one embodiment;

FIG. 2 is a functional block diagram of the mobility computer;

FIG. 3 is a functional block diagram of the power distribution management ECU;

FIG. 4 is a functional block diagram of the first zone ECU;

FIG. 5 is a functional block diagram of the first end ECU;

FIG. 6 is a diagram showing state transitions;

FIG. 7 is a flowchart showing activation control processing based on scenes;

FIG. 8 is a flowchart showing activation control processing based on scenes;

FIG. 9 is a flowchart showing stop control processing based on scenes;

FIG. 10 is a flowchart showing stop control processing based on scenes;

FIG. 11 is a diagram showing a management table;

FIG. 12 is a flowchart showing activation control processing by the timeout method;

FIG. 13 is a diagram explaining timer operation for each activation pattern;

FIG. 14 is a flowchart showing stop control processing by the timeout method;

FIG. 15 is a diagram explaining timer operation for each stop pattern;

FIG. 16 is a flowchart showing activation processing of the mobility computer;

FIG. 17 is a flowchart showing stop processing of the mobility computer;

FIG. 18 is a flowchart showing activation processing of the zone ECU;

FIG. 19 is a diagram showing state transitions of the mobility computer;

FIG. 20 is a diagram showing state transitions of the zone ECU, the power distribution management ECU, and the end ECU;

FIG. 21 is a diagram showing network configuration;

FIG. 22 is a diagram showing network configuration;

FIG. 23 is a diagram showing network configuration;

FIG. 24 is a diagram showing network configuration; and

FIG. 25 is a diagram showing network configuration.

### DETAILED DESCRIPTION

Compared to conventional configurations employing mechanical relay control, in recent years, technologies have been provided that enable the construction of various power supply states dynamically and with low power consumption by adopting high-performance semiconductor power switches (also referred to as IPD, Intelligent Power Device) through software. In configurations

employing IPDs, it becomes possible to perform power control on an ECU basis by combining start-stop control via relays based on the on/off state of the IPD and start-stop control by switching to a wake-up state or a sleep state based on communication frames. However, there may be a difficulty in that power control on an ECU basis leads to increased complexity.

The present disclosure provides a communication system, a management device, a start-stop control method for an electronic control unit, and a start-stop control program for an electronic control unit, which can appropriately perform power control on an electronic control unit basis while avoiding increased control complexity.

According to one aspect of the present disclosure, a communication system mounted on a mobile body is provided. The communication system includes: a management device; and an electronic control unit arranged to be capable of communication with the management device. The electronic control unit is configured to be activated by power supplied externally via a relay and stopped by power cutoff externally via the relay, and is further configured to, in a state in which power is supplied, perform activation by switching to a wake-up state and stop by switching to a sleep state, based on a communication frame received externally. The management device is configured to manage a scene relating to a behavior of the mobile body, and determine, when a request for activation or stop is received for the electronic control unit, based on the scene, whether to perform a first start-stop control for the electronic control unit via the relay, and determine whether to perform a second start-stop control for the electronic control unit by switching to the wake-up state or the sleep state.

According to one aspect of the present disclosure, a management device arranged to be capable of communication with an electronic control unit, within a communication system mounted on a mobile body is provided. The electronic control unit is configured to be activated by power supplied externally via a relay and stopped by power cutoff externally via the relay, and further configured to, in a state in which power is supplied, perform activation by switching to a wake-up state and stop by switching to a sleep state based on a communication frame received externally. The management device is configured to manage a scene relating to a behavior of the mobile body. When a request for activation or stop is received for the electronic control unit, the management device is configured to determine, based on the scene, whether to perform a first start-stop control for the electronic control unit via the relay, and whether to perform a second start-stop control for the electronic control unit by switching to the wake-up state or the sleep state.

According to one aspect of the present disclosure, a method for a start-stop control of an electronic control unit in a communication system including a management device and an electronic control unit arranged to be capable of communication with the management device, the electronic control unit being configured to be activated by power supplied externally via a relay and stopped by power cutoff externally via the relay, and further configured to, in a state in which power is supplied, perform activation by switching to a wake-up state and stop by switching to a sleep state based on a communication frame received externally, the communication system being mounted on a mobile body, is provided. The method includes: a first procedure of managing a scene relating to a behavior of the mobile body and receiving a request for activation or stop of the electronic control unit; and a second procedure of determining, based on the scene, whether to perform a first start-stop control for the electronic control unit via the relay, and determining whether to perform a second start-stop control for the electronic control unit by switching to the wake-up state or the sleep state.

According to one aspect of the present disclosure, a non-transitory computer readable storage medium storing a start-stop control program for an electronic control unit is provided. The program is executed by a control unit of a management device arranged to be capable of communication with an electronic control unit mounted on a mobile body. The electronic control unit is configured to be activated by power supplied externally via a relay and stopped by power cutoff externally via the relay, and further configured to, in a state in which power is supplied, perform activation by switching to a wake-up state and stop by switching to a sleep state based on a communication frame received externally. The program causes the control unit to execute: a first procedure of managing a scene relating to a behavior of the mobile body and receiving a request for activation or stop of the electronic control unit; and a second procedure of determining, based on the scene, whether to perform a first start-stop control for the electronic control unit via the relay, and determining whether to perform a second start-stop control for the electronic control unit by switching to the wake-up state or the sleep state.

According to the above configuration, when a request for activation or stop of the electronic control unit is received while managing scenes relating to the behavior of the mobile body, it is determined, based on the scene, whether or not to perform first start-stop control, and whether or not to perform second start-stop control. By determining whether or not to perform first start-stop control and second start-stop control based on scenes relating to the behavior of the mobile body, it is possible to appropriately perform power control on an electronic control unit basis while avoiding increased control complexity.

An embodiment will be described with reference to the drawings. The communication system 1 is based on a zone architecture and is configured to include a plurality of ECUs arranged in zones corresponding to installation locations such as the front, rear, left, and right of the vehicle body.

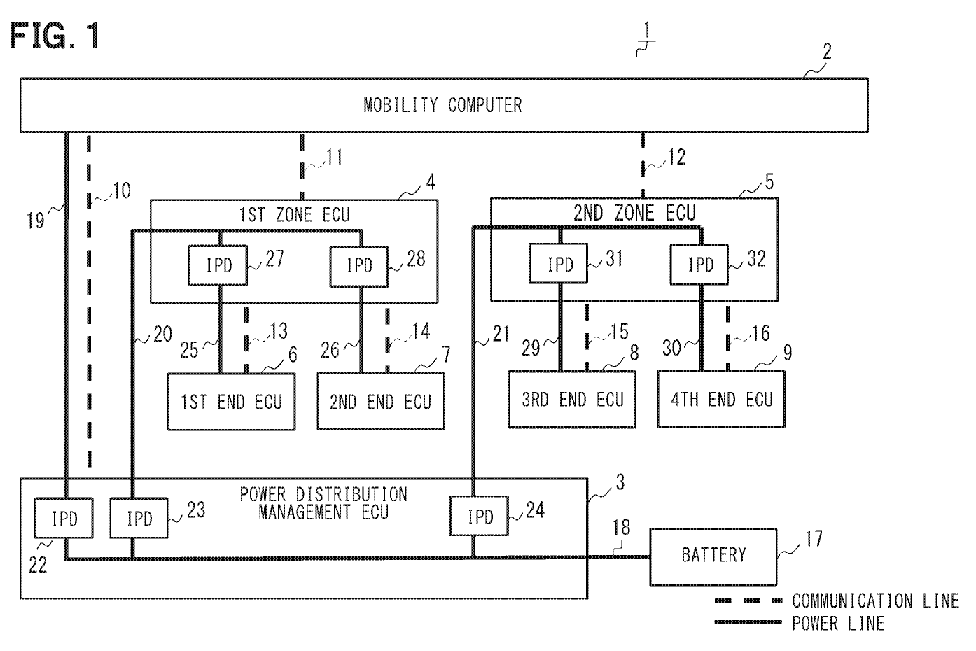

As shown in FIG. 1, the communication system 1 mounted on a vehicle (corresponding to a mobile body) includes a mobility computer 2 (also referred to as Mobicon, and corresponding to a management device), a power distribution management ECU 3 (corresponding to the power distribution management device) connected to the mobility computer 2 so as to be capable of communication, a first zone ECU 4 (corresponding to an electronic control unit, first electronic control unit) and a second zone ECU 5 (corresponding to an electronic control unit, first electronic control unit), a first end ECU 6 (corresponding to an electronic control unit, second electronic control unit) and a second end ECU 7 (corresponding to a second electronic control unit) connected to the first zone ECU 4 so as to be capable of communication, and a third end ECU 8 (corresponding to an electronic control unit, second electronic control unit) and a fourth end ECU 9 (corresponding to a second electronic control unit) connected to the second zone ECU 5 so as to be capable of communication.

In FIG. 1, two first zone ECUs 4 and 5 are exemplified as zone ECUs communicatively connected to the mobility computer 2. The number of zone ECUs connected to the mobility computer 2 may be one or more than two. Similarly, two end ECUs 6 and 7 are exemplified as end ECUs communicatively connected to the first zone ECU 4, but the number of end ECUs connected to the first zone ECU 4 may be one or three or more. Likewise, two end ECUs 8 and 9 are exemplified as end ECUs communicatively connected to the second zone ECU 5, but the number of end ECUs connected to the second zone ECU 5 may be one or three or more.

The mobility computer 2 is a control device capable of controlling the operation of the power distribution management ECU 3, the zone ECUs 4 and 5, and the end ECUs 6 to 9. The mobility computer 2 and the power distribution management ECU 3 are communicatively connected via a communication line 10. The mobility computer 2 and the first zone ECU 4 are communicatively connected via a communication line 11. The mobility computer 2 and the second zone ECU 5 are communicatively connected via a communication line 12.

The first zone ECU 4 and the first end ECU 6 are communicatively connected via a communication line 13. The first zone ECU 4 and the second end ECU 7 are communicatively connected via a communication line 14. The second zone ECU 5 and the third end ECU 8 are communicatively connected via a communication line 15. The second zone ECU 5 and the fourth end ECU 9 are communicatively connected via a communication line 16. Each of the communication lines 10 to 16 is a communication line capable of communication based on communication frames conforming to, for example, CAN (Controller Area Network) or CAN FD (CAN With Flexible Data Rate) protocols.

The power distribution management ECU 3 is supplied with power from a battery 17 via a power line 18, distributes the power supplied from the battery 17 to the mobility computer 2 and the zone ECUs 4 and 5, distributes power to the end ECUs 6 and 7 via the first zone ECU 4, and distributes power to the end ECUs 8 and 9 via the second zone ECU 5.

The power distribution management ECU 3 and the mobility computer 2 are connected via a power line 19 for power distribution. The power distribution management ECU 3 is equipped with an IPD (Intelligent Power Device) 22, which is a high-performance semiconductor power switch interposed between the power line 18 and the power line 19.

The IPD is a high-performance semiconductor power switch equipped with a built-in protection circuit and capable of absorbing energy from inductive loads and the like. The IPD may also be referred to as a semiconductor fuse, IPS (Intelligent Power Switch), smart switch, high-side/low-side switch, etc. Compared to a mechanical relay, which has mechanical contacts, the IPD does not have mechanical contacts, thereby offering superior mechanical durability and quietness, as well as the advantage of compact size. Furthermore, since the IPD is equipped with protection functions not present in mechanical relays, high reliability can also be ensured.

The IPD 22 is basically always on, and electric power from the battery 17 is constantly supplied to the mobility computer 2. In this embodiment, the IPD 22 is basically always on, but it is also possible to adopt a configuration in which the IPD 22 can be turned off. For example, in cases where the system is not used for a long period, such as during transportation by ship, temporarily turning off the IPD 22 allows suppression of quiescent current flowing to the mobility computer 2, thereby reducing power consumption of the battery 17. When the IPD 22 is temporarily turned off, power supply from the battery 17 to the mobility computer 2 is interrupted. However, during the period in which power supply is interrupted, the mobility computer 2 may be operated in a low power consumption state by battery operation, thereby enabling switching of the IPD 22 from off to on. Furthermore, it is also possible to adopt a configuration in which the mobility computer 2 and the battery 17 are directly connected, so that power from the battery 17 is constantly supplied to the mobility computer 2. In such a case, the power line 19 and the IPD 22 may be omitted.

The power distribution management ECU 3 and the first zone ECU 4 are connected via a power line 20 for power distribution. The power distribution management ECU 3 and the second zone ECU 5 are connected via a power line 21 for power distribution. The power distribution management ECU 3 is equipped with an IPD 23 interposed between power line 18 and power line 20, and an IPD 24 interposed between power line 18 and power line 21.

The power distribution management ECU 3 turns the IPD 23 on or off based on on/off instructions for the IPD 23 from the mobility computer 2, thereby switching between the power supply state and the power cutoff state for the first zone ECU 4. That is, turning the IPD 23 on initiates power supply from the power distribution management ECU 3 to the first zone ECU 4, and turning the IPD 23 off terminates power supply from the power distribution management ECU 3 to the first zone ECU 4. The power distribution management ECU 3 turns the IPD 24 on or off based on on/off instructions for the IPD 24 from the mobility computer 2, thereby switching between the power supply state and the power cutoff state for the second zone ECU 5. That is, turning the IPD 24 on initiates power supply from the power distribution management ECU 3 to the second zone ECU 5, and turning the IPD 24 off terminates power supply from the power distribution management ECU 3 to the second zone ECU 5.

The first zone ECU 4 and the first end ECU 6 are connected via a power line 25 for power distribution. The first zone ECU 4 and the second end ECU 7 are connected via a power line 26 for power distribution. The first zone ECU 4 is provided with an IPD 27, interposed between power line 20 and the power line 25, and an IPD 28, interposed between power line 20 and power line 26.

The first zone ECU 4 turns the IPD 27 on or off based on on/off instructions for the IPD 27 from the mobility computer 2, thereby switching between the power supply state and the power cutoff state for the first end ECU 6. That is, turning the IPD 27 on initiates power supply from the first zone ECU 4 to the first end ECU 6, and turning the IPD 27 off terminates power supply from the first zone ECU 4 to the first end ECU 6. The first zone ECU 4 turns the IPD 28 on or off based on on/off instructions for the IPD 28 from the mobility computer 2, thereby switching between the power supply state and the power cutoff state for the second end ECU 7. That is, turning the IPD 28 on initiates power supply from the first zone ECU 4 to the second end ECU 7, and turning the IPD 28 off terminates power supply from the first zone ECU 4 to the second end ECU 7.

The second zone ECU 5 and the third end ECU 8 are connected via a power line 29 for power distribution. The second zone ECU 5 and the fourth end ECU 9 are connected via a power line 30 for power distribution. The second zone ECU 5 is provided with an IPD 31, interposed between power line 21 and power line 29, and an IPD 32, interposed between power line 21 and power line 30.

The second zone ECU 5 turns the IPD 31 on or off based on on/off instructions for the IPD 31 from the mobility computer 2, thereby switching between the power supply state and the power cutoff state for the third end ECU 8. That is, turning the IPD 31 on initiates power supply from the second zone ECU 5 to the third end ECU 8, and turning the IPD 31 off terminates power supply from the second zone ECU 5 to the third end ECU 8. The second zone ECU 5 turns the IPD 32 on or off based on on/off instructions for the IPD 32 from the mobility computer 2, thereby switching between the power supply state and the power cutoff state for the fourth end ECU 9. That is, turning the IPD 32 on initiates power supply from the second zone ECU 5 to the fourth end ECU 9, and turning the IPD 32 off terminates power supply from the second zone ECU 5 to the fourth end ECU 9.

In the above configuration, it is also possible for a part of the zone ECUs 4, 5 and end ECUs 6 to 9 to be directly connected to the battery 17 so that power from the battery 17 is constantly supplied.

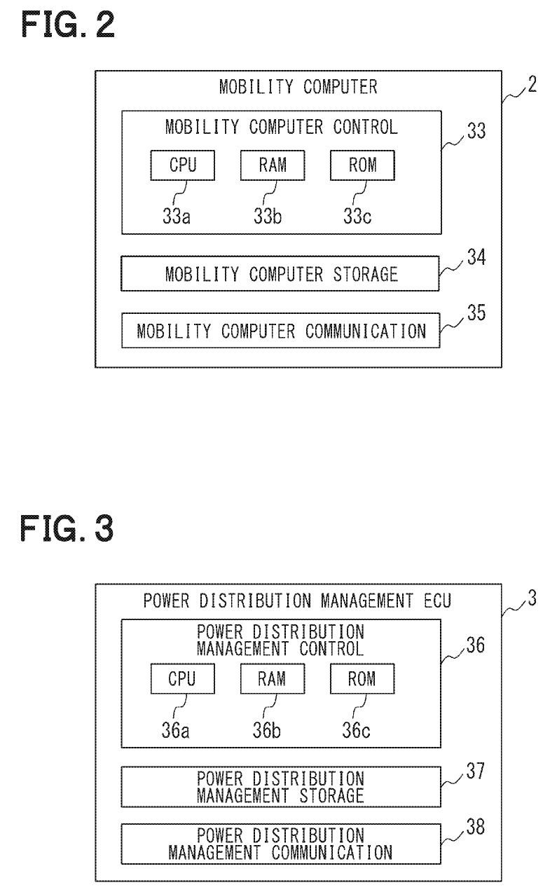

As shown in FIG. 2, the mobility computer 2 includes a mobility computer control unit 33 (corresponding to the control unit), a mobility computer storage section 34, and a mobility computer communication section 35. The mobility computer control unit 33 is a device that performs various arithmetic processing related to the operation of the mobility computer 2 and is mainly composed of, for example, a microcomputer (also referred to as a microcontroller) having a CPU 33a, RAM 33b, ROM 33c, and the like. Various functions of the mobility computer control unit 33 are implemented by the CPU 33a executing programs stored in a non-transitory tangible recording medium. The non-transitory tangible recording medium is, for example, the ROM 33c. When the program is executed by the CPU 33a, the method corresponding to the program is executed. In this embodiment, when the start-stop control program for the electronic control unit is executed by the CPU 33a, the start-stop control method corresponding to the start-stop control program for the electronic control unit is executed. The mobility computer control unit 33 may be constituted by one or more microcontrollers. Further, the means for realizing various functions of the mobility computer control unit 33 is not limited to software, and some or all of the elements may be implemented using one or more hardware components. For example, when the above-described functions are implemented by electronic circuits as hardware, the electronic circuits may be digital circuits including a large number of logic circuits, analog circuits, or a combination thereof.

The mobility computer storage section 34 is, for example, a nonvolatile memory, such as a rewritable flash memory or EEPROM. The vehicle power state, which will be described later, is stored in the mobility computer storage section 34. The mobility computer communication section 35 controls data communication with the power distribution management ECU 3 via communication line 10, data communication with the first zone ECU 4 via communication line 11, and data communication with the second zone ECU 5 via communication line 12.

As shown in FIG. 3, the power distribution management ECU 3 includes a power distribution management control unit 36, a power distribution management storage section 37, and a power distribution management communication section 38.

The power distribution management control unit 36 is a device that performs various arithmetic processing related to the operation of the power distribution management ECU 3, and is mainly composed of a microcontroller having a CPU 36a, RAM 36b, ROM 36c, and the like. Various functions of the power distribution management control unit 36 are implemented by the CPU 36a executing programs stored in a non-transitory tangible recording medium. The non-transitory tangible recording medium is, for example, the ROM 36c. When the program is executed by the CPU 36a, the method corresponding to the program is executed. In this embodiment, when the vehicle power state management program is executed by the CPU 36a, the management method corresponding to the vehicle power state management program is executed. The power distribution management control unit 36 may be constituted by one or more microcontrollers. Furthermore, the means for realizing various functions of the power distribution management control unit 36 is not limited to software, and some or all of the elements may be implemented using one or more hardware components. For example, when the above-described functions are implemented by electronic circuits as hardware, the electronic circuits may be digital circuits including a large number of logic circuits, analog circuits, or a combination thereof.

The power distribution management storage section 37 is, for example, a nonvolatile memory, such as a rewritable flash memory or EEPROM. The vehicle power state is stored in the power distribution management storage section 37. In addition to the power distribution management storage section 37, a volatile memory may be provided, and the vehicle power state may be stored in the volatile memory. The power distribution management communication section 38 controls data communication with the mobility computer 2 via communication line 10.

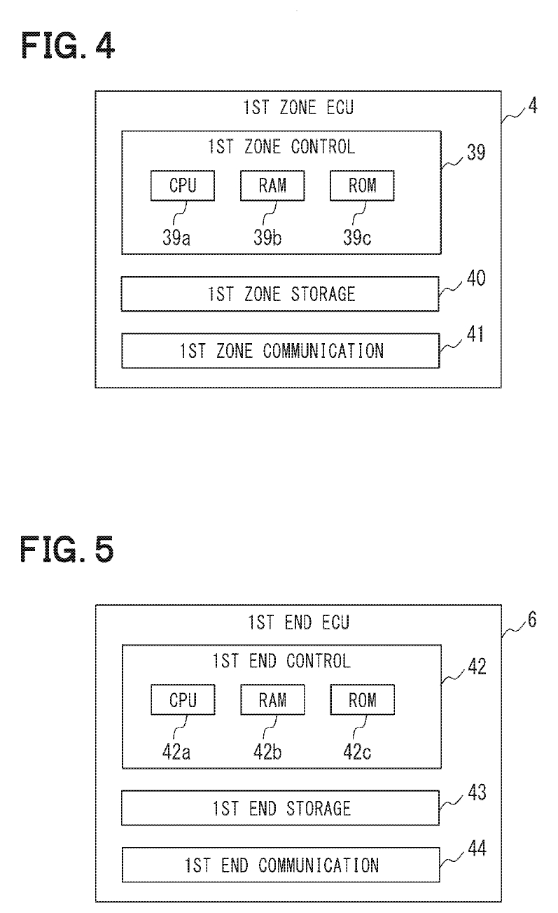

As shown in FIG. 4, the first zone ECU 4 includes a first zone control unit 39, a first zone storage section 40, and a first zone communication section 41. The second zone ECU 5 has the same configuration as the first zone ECU 4.

The first zone control unit 39 is a device that performs various arithmetic processing related to the operation of the first zone ECU 4, and is mainly composed of a microcontroller having a CPU 39a, RAM 39b, ROM 39c, and the like. Various functions of the first zone control unit 39 are implemented by the CPU 39a executing programs stored in a non-transitory tangible recording medium. The non-transitory tangible recording medium is, for example, the ROM 39c. When the program is executed by the CPU 39a, the method corresponding to the program is executed. In this embodiment, when the vehicle power state management program is executed by the CPU 39a, the management method corresponding to the vehicle power state management program is executed. The first zone control unit 39 may be constituted by one or more microcontrollers. Furthermore, the means for realizing various functions of the first zone control unit 39 is not limited to software, and some or all of the elements may be implemented using one or more hardware components. For example, when the above-described functions are implemented by electronic circuits as hardware, the electronic circuits may be digital circuits including a large number of logic circuits, analog circuits, or a combination thereof.

The first zone storage section 40 is, for example, a nonvolatile memory, such as a rewritable flash memory or EEPROM. The vehicle power state is stored in the first zone storage section 40. In addition to the first zone storage section 40, a volatile memory may be provided, and the vehicle power state may be stored in the volatile memory. The first zone communication section 41 controls data communication with the mobility computer 2 via a communication line 11, data communication with the first end ECU 6 via a communication line 13, and data communication with the second end ECU 7 via a communication line 14.

As shown in FIG. 5, the first end ECU 6 includes a first end control unit 42, a first end storage section 43, and a first end communication section 44. The second end ECU 7, the third end ECU 8, and the fourth end ECU 9 have the same configuration as the first end ECU 6.

The first end control unit 42 is a device that performs various arithmetic processing related to the operation of the first end ECU 6, and is mainly composed of a microcontroller having a CPU 42a, RAM 42b, ROM 42c, and the like. Various functions of the first end control unit 42 are implemented by the CPU 42a executing programs stored in a non-transitory tangible recording medium. The non-transitory tangible recording medium is, for example, the ROM 42c. When the program is executed by the CPU 42a, the method corresponding to the program is executed. In this embodiment, when the vehicle power state management program is executed by the CPU 42a, the management method corresponding to the vehicle power state management program is executed. The first end control unit 42 may be constituted by one or more microcontrollers. Furthermore, the means for realizing various functions of the first end control unit 42 is not limited to software, and some or all of the elements may be implemented using one or more hardware components. For example, when the above-described functions are implemented by electronic circuits as hardware, the electronic circuits may be digital circuits including a large number of logic circuits, analog circuits, or a combination thereof.

The first end storage section 43 is, for example, a nonvolatile memory, such as a rewritable flash memory or EEPROM. The vehicle power state is stored in the first end storage section 43. In addition to the first end storage section 43, a volatile memory may be provided, and the vehicle power state may be stored in the volatile memory. The first end communication section 44 controls data communication with the first zone ECU 4 via communication line 13.

In the communication system 1, a start-stop control via a relay based on the on/off state of the IPD (also referred to as start-stop control via a relay, corresponding to a first start-stop control) and a start-stop control by switching to a wake-up state or a sleep state based on a communication frame (also referred to as NM (Network Management) frame or a NM message; also referred to as a start-stop control based on a communication frame, corresponding to a second start-stop control) are performed in combination. The start-stop control via the relay includes start control via a relay based on turning the IPD on and stop control via a relay based on turning the IPD off. The start-stop control based on a communication frame includes the start control by switching from a sleep state to a wake-up state based on a communication frame for a wake-up request, and the stop control by switching from a wake-up state to a sleep state based on a communication frame for a sleep request.

The start-stop control via a relay uses an IPD ON signal for instructing the IPD to turn on, and an IPD OFF signal for instructing the IPD to turn off. That is, an ECU that receives an IPD ON signal from the mobility computer 2 turns on the IPD specified by the received IPD ON signal and starts supplying power to the subordinate ECUs connected to the IPD that has been turned on, which may also be referred to as a powered IPD. An ECU that receives an IPD OFF signal from the mobility computer 2 turns off the IPD specified by the received IPD OFF signal and terminates power supply to the subordinate ECUs connected to the IPD that has been turned off, which may also be referred to as a powered-off IPD.

The start-stop control based on a communication frame utilizes the value of a predetermined bit in the data field of the communication frame. For example, a communication frame in which the predetermined bit of the data field is set to "1" is used as a communication frame for a wake-up request, and a communication frame in which the predetermined bit of the data field is set to "0" is used as a communication frame for a sleep request. That is, when an ECU receives a communication frame from the mobility computer 2, it determines the value stored in the predetermined bit of the received communication frame. If the value is "1", the ECU transitions from the sleep state to the wake-up state or maintains the wake-up state, and if the value is "0", the ECU transitions from the wake-up state to the sleep state or maintains the sleep state. Furthermore, as long as the ECU periodically receives a wake-up request communication frame from the mobility computer 2 at a predetermined interval, it remains in the wake-up state. If the reception of the wake-up request communication frame is interrupted for a certain period, the ECU may transition from the wake-up state to the sleep state. The wake-up state is a normal operating state in which the functions assigned to the ECU are available without restriction. The sleep state is a low power consumption operating state in which available functions are restricted. The communication frame is not limited to being transmitted from the mobility computer 2, but may also be transmitted from another ECU. Note that, in the data field of a communication frame (for example, an NM frame), control information for a plurality of electronic control units may be assigned to a plurality of bits. For example, activation information for a specific electronic control unit may be assigned to the most significant first bit of the data field, activation information for another electronic control unit may be assigned to the most significant second bit, activation information for yet another electronic control unit may be assigned to the most significant third bit, and activation information for still another electronic control unit may be assigned to the most significant fourth bit, respectively. In this manner, the corresponding electronic control unit may be controlled to transition to a wake-up state or a sleep state according to the value (for example, "1" or "0") of each bit in the communication frame. Thus, by utilizing a plurality of bits in the communication frame, the states of a plurality of electronic control units may be controlled simultaneously by a single communication frame.

As the start-stop control via a relay, the mobility computer 2 transmits an IPD ON signal to the ECU positioned upstream of the ECU to be controlled, and performs the start control for the target ECU by turning on the IPD, and transmits an IPD OFF signal to perform the stop control for the target ECU by turning off the IPD. That is, for example, when the target ECU is the first zone ECU 4, the mobility computer 2 transmits an IPD ON signal to the power distribution management ECU 3 positioned upstream of the first zone ECU 4, and activates the first zone ECU 4 by turning on the IPD 23, and transmits an IPD OFF signal to stop the first zone ECU 4 by turning off the IPD 23. Similarly, when the target ECU is the first end ECU 6, the mobility computer 2 transmits an IPD ON signal to the first zone ECU 4 positioned upstream of the first end ECU 6, and activates the first end ECU 6 by turning on the IPD 27, and transmits an IPD OFF signal to stop the first end ECU 6 by turning off the IPD 27.

As the start-stop control based on a communication frame, the mobility computer 2 transitions the target ECU to the wake-up state by transmitting a communication frame for a wake-up request addressed to the target ECU, and transitions the target ECU to the sleep state by transmitting a communication frame for a sleep request. That is, for example, when the target ECU is the first zone ECU 4, the mobility computer 2 transitions the first zone ECU 4 to the wake-up state by transmitting a communication frame for a wake-up request addressed to the first zone ECU 4, and transitions it to the sleep state by transmitting a communication frame for a sleep request. Similarly, when the target ECU is the first end ECU 6, the mobility computer 2 transitions the first end ECU 6 to the wake-up state by transmitting a communication frame for a wake-up request addressed to the first end ECU 6, and transitions it to the sleep state by transmitting a communication frame for a sleep request. An ECU to which power supply has been started by turning on the upstream IPD naturally enters the wake-up state, so it is unnecessary for the mobility computer 2 to transmit a communication frame for a wake-up request to an ECU that has already started receiving power.

In the above configuration, the system performs the following operations:

(1) Start-stop control based on scenes,

(2) Start-stop control using the timeout method,

(3) Management of the vehicle power state.

The following describes each operation in sequence.

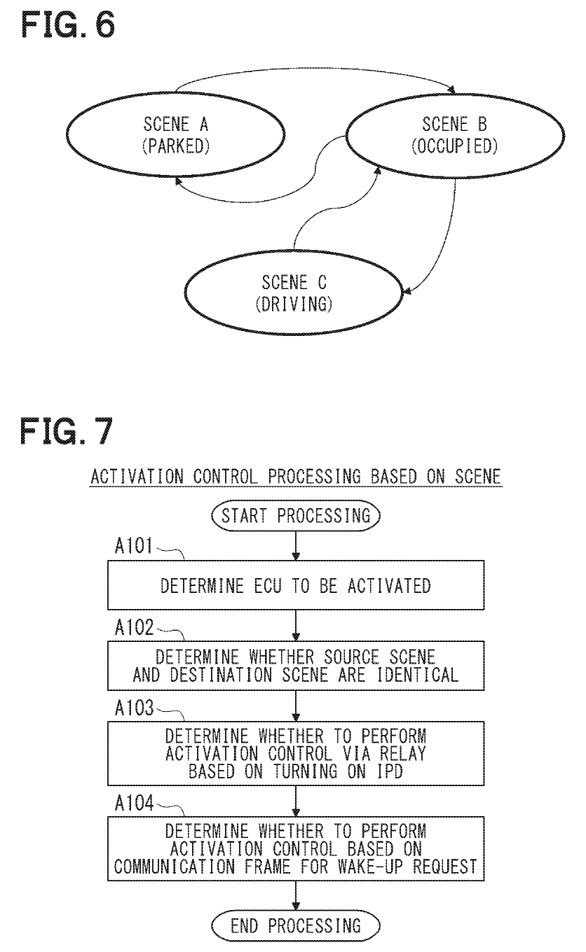

### 1 Start-Stop Control Based on Scenes referring to FIG. 6 to FIG. 11

In the start-stop control based on scenes, the mobility computer 2 manages scenes relating to vehicle behavior, and when an activation request or stop request for a target ECU occurs, determines, based on the destination scene, whether to perform the start-stop control via a relay and whether to perform the start-stop control based on a communication frame. Note that turning the IPD on may also be referred to as "relay ON," and turning the IPD off may also be referred to as "relay OFF." Additionally, the mobility computer 2 manages functions within the scene, and when a start-stop request for a target ECU occurs, determines, based on the type of function, whether to perform the start-stop control via a relay and whether to perform the start-stop control based on a communication frame. Here, a "scene" includes the concepts of vehicle state and function. "Vehicle state" includes not only concepts such as parked, occupied, and driving, but also concepts of vehicle power states such as +B state, ACC state, and IG state. "Function" includes not only the concept of functions executed by so-called applications, but also the concept of subsystems composed of one or more ECUs.

As shown in FIG. 6, as scenes for the entire vehicle, scenes A, B, and C are assumed, and a state transition between scene A and scene B, and a state transition between scene B and scene C are considered. Scene A is, for example, a parked state, scene B is, for example, an occupied state, and scene C is, for example, a driving state. The following describes activation control and the stop control. Scenes are determined by the mobility computer 2 and stored in the mobility computer storage section 34.

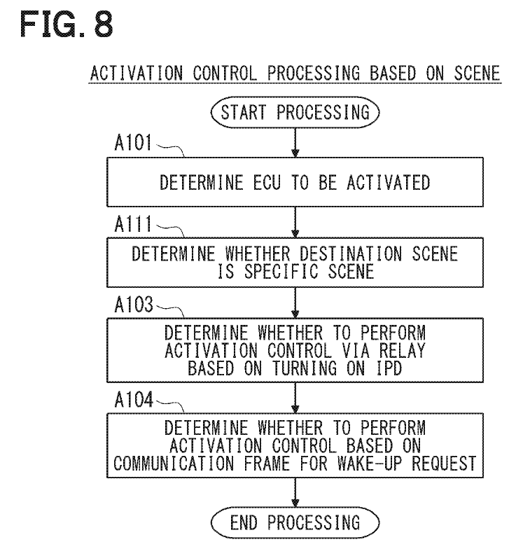

### 1-1 Activation Control Processing Based on Scenes see FIG. 7 to FIG. 8

As shown in FIG. 7, when the mobility computer 2 receives an activation request from, for example, an application (corresponding to the first procedure), it identifies the received activation request and determines the ECU to be activated (A101). In this case, there are the following patterns for receiving an activation request.

The first pattern is when the mobility computer 2 receives an activation request for a target ECU from its own module or another ECU. In this case, when the mobility computer 2 receives an activation request for a target ECU from its own module or another ECU, it determines the ECU to be activated based on the received activation request.

The second pattern is when the mobility computer 2 receives a start request for a predetermined function from its own module or another ECU. In this case, when the mobility computer 2 receives a start request for a predetermined function from its own module or another ECU, it determines the function to be activated based on the received start request for the predetermined function, and determines the ECU associated with the determined function as the ECU to be activated.

The third pattern is when the mobility computer 2 receives an execution request for a start event from its own module or another ECU. In this case, when the mobility computer 2 receives an execution request for a start event from its own module or another ECU, it determines the function associated with the received execution request for the start event as the function to be activated, and determines the ECU associated with the determined function as the ECU to be activated.

Since activation requests for the target ECU, start requests for predetermined functions, and execution requests for start events may occur simultaneously from a plurality of applications, the mobility computer 2 determines the ECU to be activated according to logical AND or logical OR operations. For example, the mobility computer 2 determines as the ECU to be activated any ECU for which at least one activation request has been received, and determines as the ECU to be stopped any ECU for which all received requests are stop requests.

When the mobility computer 2 determines the ECU to be activated, it determines whether the source scene and the destination scene are identical (step A102). Based on the result of determining whether the source scene and the destination scene are the same, the mobility computer 2 decides whether to perform the start control via a relay by turning on the IPD (A103, corresponding to the second procedure), and whether to perform the start control based on a communication frame for a wake-up request (A104, corresponding to the second procedure).

That is, for example, if the received activation request is an activation request that remains in the parked scene and the source scene and the destination scene are identical, the mobility computer 2 determines not to perform the start control via a relay based on turning on the IPD, and to perform only the start control based on a communication frame for a wake-up request. If, for example, the received activation request involves a state transition from the parked scene to the occupied scene and the source scene and the destination scene are different, the mobility computer 2 determines to perform both the start control via a relay based on turning on the IPD and the start control based on a communication frame for a wake-up request.

The above describes the case where it is determined whether the source scene and the destination scene are identical . However, as shown in FIG. 8, the mobility computer 2 may, instead of determining whether the source scene and the destination scene are identical, determine whether the destination scene is a specific scene (step A111), and based on the result of that determination, decide whether to perform the start control via a relay based on turning on the IPD (A103), and whether to perform the start control based on a communication frame for a wake-up request (A104).

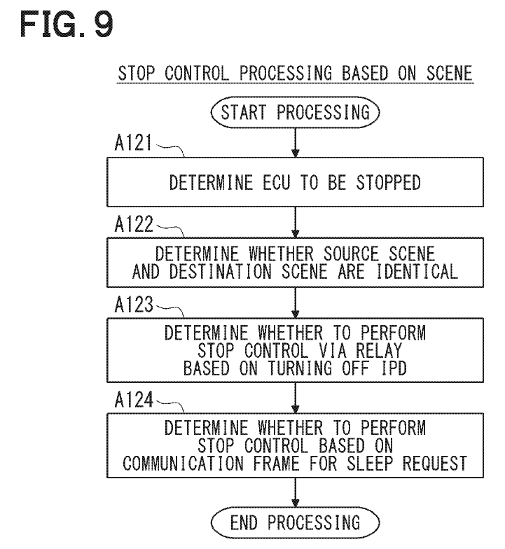

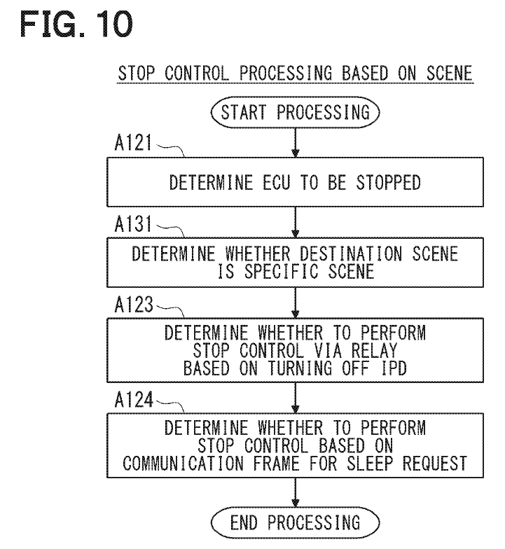

### 1-2 Stop Control Processing Based on Scenes referring to FIG. 9 to FIG. 10

As shown in FIG. 9, when the mobility computer 2 receives a stop request from, for example, an application (corresponding to the first procedure), it identifies the received stop request and determines the ECU to be stopped (A121). In this case, there are the following patterns for receiving a stop request:

The first pattern is when the mobility computer 2 receives a stop request for the target ECU from its own module or another ECU. In this case, when the mobility computer 2 receives a stop request for the target ECU from its own module or another ECU, it determines the ECU to be stopped based on the received stop request.

The second pattern is when the mobility computer 2 receives a termination request for a predetermined function from its own module or another ECU. In this case, when the mobility computer 2 receives a termination request for a predetermined function from its own module or another ECU, it determines the function to be stopped based on the received termination request for the predetermined function, and determines the ECU associated with the determined function as the ECU to be stopped.

The third pattern is when the mobility computer 2 receives an execution request for an end event from its own module or another ECU. In this case, when the mobility computer 2 receives an execution request for an end event from its own module or another ECU, it determines the function associated with the received execution request for the end event as the function to be stopped, and determines the ECU associated with the determined function as the ECU to be stopped.

Since stop requests for the target ECU, termination requests for predetermined functions, and execution requests for end events may occur simultaneously from a plurality of applications, the mobility computer 2 determines the ECU to be stopped according to logical AND or logical OR operations. For example, the mobility computer 2 determines as the ECU to be stopped any ECU for which at least one stop request has been received, and determines as the ECU to be activated any ECU for which all received requests are activation requests.

When the mobility computer 2 determines the ECU to be stopped, it determines whether the source scene and the destination scene are identical (step A122). Based on the result of determining whether the source scene and the destination scene are identical, the mobility computer 2 decides whether to perform the stop control via a relay based on turning off the IPD (A123, corresponding to the second procedure), and whether to perform the stop control based on a communication frame for a sleep request (A124, corresponding to the second procedure).

That is, for example, if the received stop request is a stop request that remains in the parked scene and the source scene and the destination scene are identical, the mobility computer 2 determines not to perform the stop control via a relay based on turning off the IPD, and to perform only the stop control based on a communication frame for a sleep request. If, for example, the received stop request involves a state transition from the parked scene to the occupied scene and the source scene and the destination scene are different, the mobility computer 2 determines to perform both the stop control via a relay based on turning off the IPD and the stop control based on a communication frame for a sleep request.

The above describes the case where it is determined whether the source scene and the destination scene are identical . However, as shown in FIG. 10, the mobility computer 2 may, instead of determining whether the source scene and the destination scene are identical, determine whether the destination scene is a specific scene (step A131), and based on the result of that determination, decide whether to perform the stop control via a relay based on turning off the IPD (A123), and whether to perform the stop control based on a communication frame for a sleep request (A124).

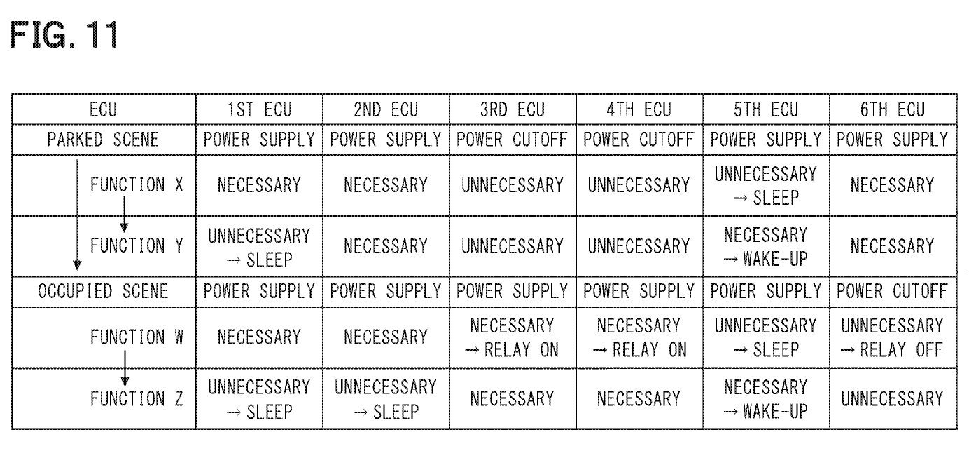

As shown in FIG. 11, the mobility computer 2 manages, for example, a management table for each scene, such as a parked scene or an occupied scene. The management table may be arranged (stored) in an area separate from the control program or may be incorporated within the control program. The first ECU to the sixth ECU correspond, for example, to any of the power distribution management ECU 3, zone ECUs 4 and 5, or end ECUs 6 to 9 described in FIG. 1. For each scene, ECUs that are to be supplied with power by default and ECUs for which power is to be cut off are defined. In the example shown in FIG. 11, in the parked scene, the first ECU, the second ECU, the fifth ECU, and the sixth ECU are defined as ECUs to be supplied with power, and the third ECU and the fourth ECU are defined as ECUs for which power is to be cut off. In the occupied scene, the first ECU, the second ECU, the third ECU, the fourth ECU, and the fifth ECU are defined as ECUs to be supplied with power, and the sixth ECU is defined as an ECU for which power is to be cut off.

When transitioning from the parked scene to the occupied scene, the mobility computer 2 performs the start control by relay ON for the third ECU and the fourth ECU, since "power cutoff" is defined for these ECUs in the parked scene and "power supply" is defined in the occupied scene. Also, when transitioning from the parked scene to the occupied scene, the mobility computer 2 performs the stop control by relay OFF for the sixth ECU, since "power supply" is defined for the sixth ECU in the parked scene and "power cutoff" is defined in the occupied scene.

Within the parked scene, if, as in the first pattern described above, the mobility computer 2 identifies that activation requests have occurred for the first ECU, the second ECU, and the sixth ECU associated with function X, it determines that activation of the first ECU, the second ECU, and the sixth ECU is necessary. Also, as in the second pattern described above, if the mobility computer 2 identifies that a start request for function X has occurred, it determines the first ECU, the second ECU, and the sixth ECU associated with function X as the ECUs for the activation request, and determines that activation of the first ECU, the second ECU, and the sixth ECU is necessary. Furthermore, as in the third pattern described above, if the mobility computer 2 identifies that an execution request for a start event has occurred and that the start event is associated with function X, it determines function X as the function to be activated, determines the first ECU, the second ECU, and the sixth ECU associated with function X as the ECUs for the activation request, and determines that activation of the first ECU, the second ECU, and the sixth ECU is necessary.

The mobility computer 2 continues to supply power to the first ECU, the second ECU, and the sixth ECU identified as requiring activation. The mobility computer 2 performs the stop control for the fifth ECU, identified as not requiring activation, by switching from the wake-up state to the sleep state.

Similarly, within the parked scene, if, as in the first pattern described above, the mobility computer 2 identifies that activation requests have occurred for the second ECU, the fifth ECU, and the sixth ECU associated with function Y, it determines that activation of the second ECU, the fifth ECU, and the sixth ECU is necessary. Also, as in the second pattern described above, if the mobility computer 2 identifies that a start request for function Y has occurred, it determines the second ECU, the fifth ECU, and the sixth ECU associated with function Y as the ECUs for the activation request, and determines that activation of the second ECU, the fifth ECU, and the sixth ECU is necessary. Furthermore, as in the third pattern described above, if the mobility computer 2 identifies that an execution request for a start event has occurred and that the start event is associated with function Y, it determines function Y as the function to be activated, determines the second ECU, the fifth ECU, and the sixth ECU associated with function Y as the ECUs for the activation request, and determines that activation of the second ECU, the fifth ECU, and the sixth ECU is necessary.

The mobility computer 2 continues to supply power to the second ECU and the sixth ECU identified as requiring activation. The mobility computer 2 performs activation control for the fifth ECU, identified as requiring activation, by switching from the sleep state to the wake-up state. The mobility computer 2 performs the stop control for the first ECU, identified as not requiring activation, by switching from the wake-up state to the sleep state.

In FIG. 11, the case where function X is terminated and function Y is started is exemplified, but there may also be cases where function Y is started while function X continues without termination. In such cases, the mobility computer 2 does not perform the stop control for the first ECU by switching from the wake-up state to the sleep state, but continues the wake-up state of the first ECU.

Within the occupied scene, if, as in the first pattern described above, the mobility computer 2 identifies that activation requests have occurred for the first ECU, second ECU, third ECU, and fourth ECU associated with function W, it determines that activation of the first ECU, second ECU, third ECU, and fourth ECU is necessary. Also, as in the second pattern described above, if the mobility computer 2 identifies that a start request for function W has occurred, it determines the first ECU, second ECU, third ECU, and fourth ECU associated with function W as the ECUs for the activation request, and determines that activation of the first ECU, second ECU, third ECU, and fourth ECU is necessary. Furthermore, as in the third pattern described above, if the mobility computer 2 identifies that an execution request for a start event has occurred and that the start event is associated with function W, it determines function W as the function to be activated, determines the first ECU, the second ECU, the third ECU, and the fourth ECU associated with function W as the ECUs for the activation request, and determines that activation of the first ECU, the second ECU, the third ECU, and the fourth ECU is necessary.

The mobility computer 2 continues to supply power to the first ECU and the second ECU identified as requiring activation. The mobility computer 2 performs activation control by relay ON for the third ECU and the fourth ECU identified as requiring activation. The mobility computer 2 performs the stop control for the fifth ECU identified as not requiring activation by switching from the wake-up state to the sleep state. The mobility computer 2 performs the stop control for the sixth ECU identified as not requiring activation by relay OFF.

Similarly, within the occupied scene, if, as in the first pattern described above, the mobility computer 2 identifies that activation requests have occurred for the third ECU, the fourth ECU, and the fifth ECU associated with function Z, it determines that activation of the third ECU, the fourth ECU, and the fifth ECU is necessary. Also, as in the second pattern described above, if the mobility computer 2 identifies that a start request for function Z has occurred, it determines the third ECU, the fourth ECU, and the fifth ECU associated with function Z as the ECUs for the activation request, and determines that activation of the third ECU, the fourth ECU, and the fifth ECU is necessary. Furthermore, as in the third pattern described above, if the mobility computer 2 identifies that an execution request for a start event has occurred and that the start event is associated with function Z, it determines function Z as the function to be activated, determines the third ECU, the fourth ECU, and the fifth ECU associated with function Z as the ECUs for the activation request, and determines that activation of the third ECU, the fourth ECU, and the fifth ECU is necessary.

The mobility computer 2 continues to supply power to the third ECU and the fifth ECU identified as requiring activation. The mobility computer 2 performs activation control for the fifth ECU identified as requiring activation by switching from the sleep state to the wake-up state. The mobility computer 2 performs the stop control for the first ECU and the second ECU identified as not requiring activation by switching from the wake-up state to the sleep state.

In FIG. 11, the case where function W is terminated and function Z is started is exemplified, but there may also be cases where function Z is started while function W continues without termination. In such cases, the mobility computer 2 does not perform the stop control for the first ECU and the second ECU by switching from the wake-up state to the sleep state, but continues the wake-up state of the first ECU and the second ECU.

In the definition of scenes, for example, if the target ECU dynamically changes while continuing a parked scene in which vehicle diagnostics, vehicle information collection, or software updates are performed via OTA (Over the Air), in such a case, it is defined as a separate scene, and it is determined whether to perform the start-stop control via a relay and whether to perform the start-stop control based on a communication frame.

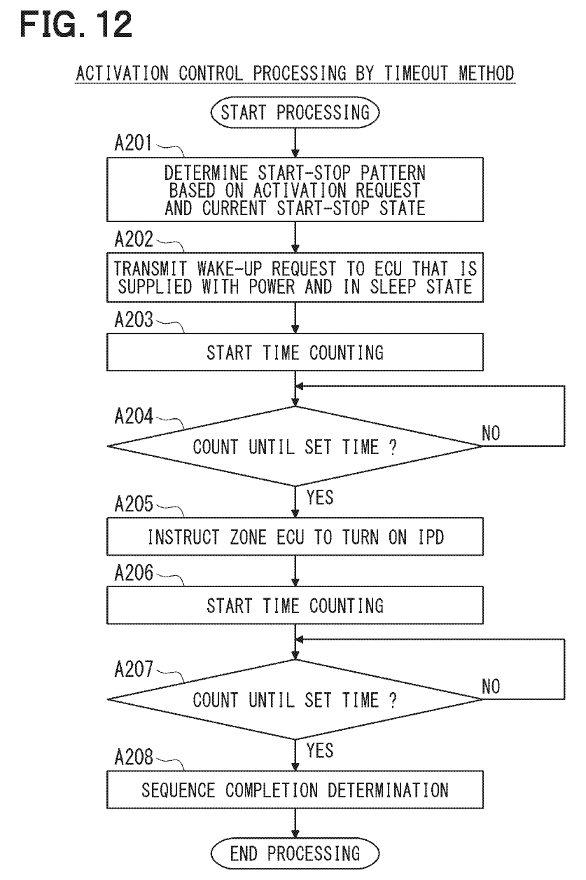

### 2 Start-Stop Control by Timeout Method referring to FIG. 12 to FIG. 15

As shown in FIG. 1, the first zone ECU 4 and the second zone ECU 5 are arranged under the power distribution management ECU 3 in terms of power supply, and the end ECUs 6 and 7 are arranged under the first zone ECU 4, while the end ECUs 8 and 9 are arranged under the second zone ECU 5. In terms of communication, the power distribution management ECU 3, the first zone ECU 4, and the second zone ECU 5 are arranged under the mobility computer 2, the end ECUs 6 and 7 are arranged under the first zone ECU 4, and the end ECUs 8 and 9 are arranged under the second zone ECU 5. In such a hierarchical architecture, it is necessary to perform power supply and switch from the sleep state to the wake-up state sequentially from the upper level downward. In this case, after executing the control sequence for the upper-level target ECU, the control sequence for the lower-level target ECU is executed. Conversely, it is necessary to perform power cutoff and switch from the wake-up state to the sleep state sequentially from the lower level upward. In this case, after executing the control sequence for the lower-level target ECU, the control sequence for the upper-level target ECU is executed.

In the start-stop control by the timeout method, after starting the control sequence for a certain hierarchy, time counting is started, and when the set time has elapsed, the control sequence for the next hierarchy is started. In activation control, when the overall control sequence is defined as the control sequence from the highest-level target ECU to the lowest-level target ECU, the control sequence is started from the highest-level target ECU and time counting is started; when the set time has elapsed, the control sequence for the next hierarchy is started. That is, each time the set time for the upper-level control sequence is counted, the lower-level control sequence is started, and by counting up to the set time for the control sequence of the lowest-level target ECU, the overall control sequence is completed.

In the stop control, when the overall control sequence is defined as the control sequence from the lowest-level target ECU to the highest-level target ECU, the control sequence is started from the lowest-level target ECU and time counting is started; when the set time has elapsed, the control sequence for the next hierarchy is started. That is, each time the set time for the lower-level control sequence is counted, the upper-level control sequence is started, and by counting up to the set time for the control sequence of the highest-level target ECU, the overall control sequence is completed.

Even if the execution of a control sequence is not completed normally, the control sequence for the next hierarchy is started. In this case, the hierarchy where start-stop failed maintains its state, and the execution of the control sequence is completed.

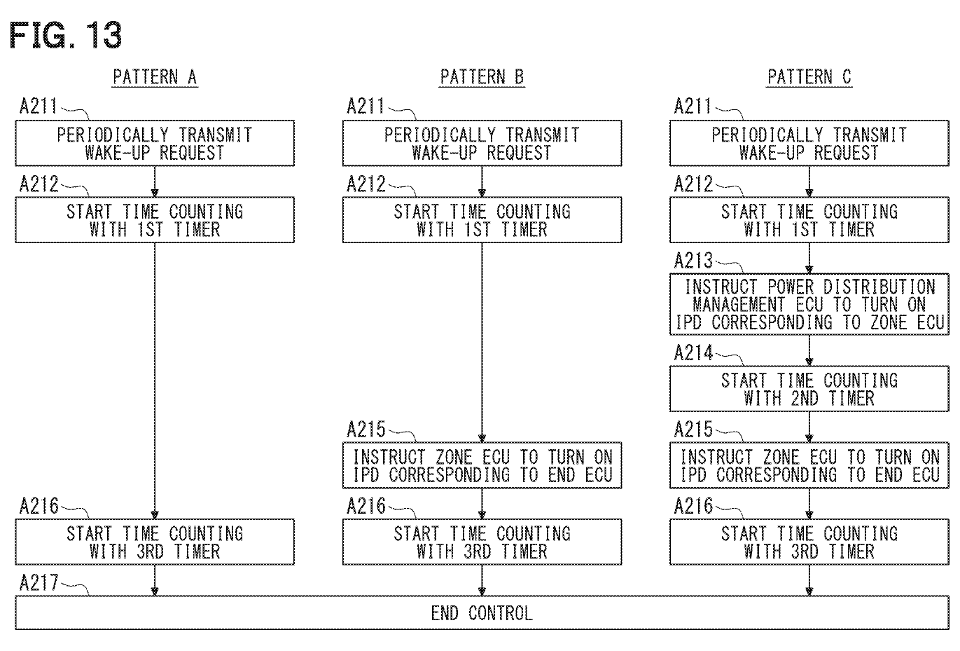

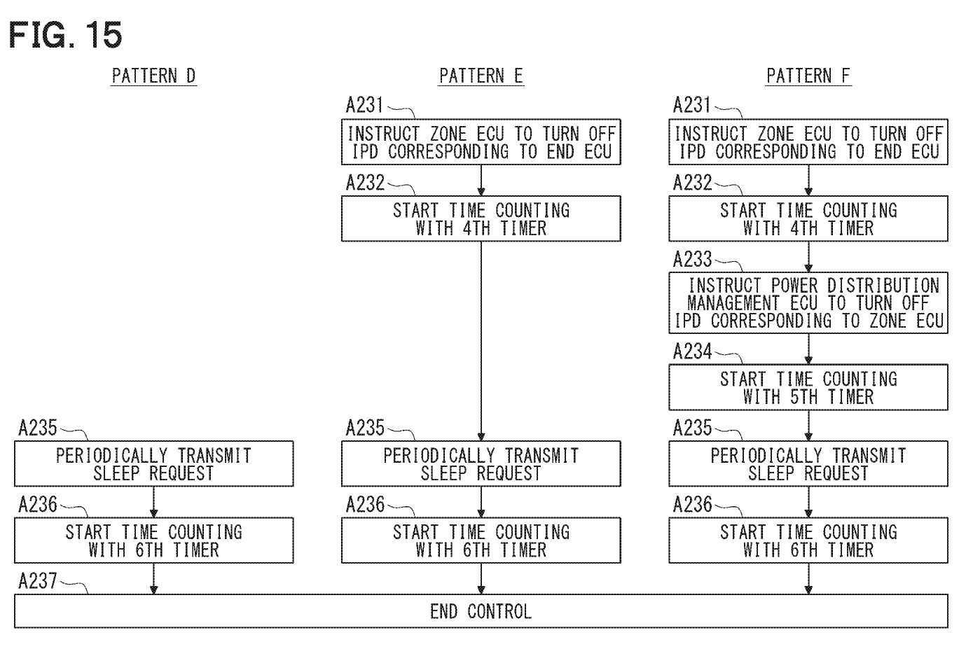

When multiple control sequences are executed simultaneously, the set time for each control sequence is set to match the control sequence with the longest execution time among the multiple control sequences, so that a common parameter is set for the entire system, or the time may be set individually for each zone. In FIG. 1, for example, if it is necessary to activate the first end ECU 6 and the second end ECU 7 arranged under the first zone ECU 4, and the third end ECU 8 arranged under the second zone ECU 5, the set time for the overall control sequence including the first zone ECU 4 and the set time for the overall control sequence including the second zone ECU 5 are set to follow the control sequence with the longest execution time. The setting of the timer's set time will be described later with reference to FIGS. 13 and 15.

If a sudden increase in power consumption is anticipated due to simultaneous activation of multiple IPDs, the activation timing of the end ECUs in each zone is adjusted. If activation or stop of an ECU fails, only some ECUs will be in the activated or stopped state, so for ECUs where start-stop has failed, the fail-safe function of each domain is applied based on the safety philosophy of that domain. When multiple control sequences are executed in parallel, processing such as starting time counting individually for each control sequence, or waiting until the time counting for the preceding control sequence is completed with a single time count, is performed.

### 2-1 Activation Control Processing by Timeout Method referring to FIG. 12 to FIG. 13

In FIG. 1, it is assumed that the power distribution management ECU 3, the first zone ECU 4, and the end ECUs 6 and 7 are in the following states, and the activation control processing will be described.

Power distribution management ECU 3: Constantly supplied with power, in the sleep state,

First zone ECU 4: Supplied with power, in the sleep state,

First end ECU 6: Supplied with power, in the sleep state, and

Second end ECU 7: Not supplied with power.

Here, the state of being supplied with power includes both cases: one where the IPD of the upper-level ECU is always ON or directly connected to battery 17 for constant power supply, and another where power is supplied as needed by turning ON the IPD of the upper-level ECU.

As shown in FIG. 12, when the mobility computer 2 receives an activation request from, for example, an application, it determines the start-stop pattern based on the received activation request and the current start-stop state (A201). That is, the mobility computer 2 determines the start-stop pattern according to FIG. 11 described above. The mobility computer 2 transmits a communication frame for a wake-up request to ECUs that are supplied with power and are in the sleep state (A202), and starts time counting (A203). In this case, the mobility computer 2 transmits a communication frame for a wake-up request to the power distribution management ECU 3 and the first zone ECU 4, which are supplied with power and are in the sleep state, and starts time counting.

The mobility computer 2 waits for the count to reach a preset set time, and when it is determined that the count has reached the set time (step A204: YES), it instructs the zone ECU to turn ON the IPD corresponding to the end ECU that is not supplied with power (A205), and starts time counting (A206). Even if normal completion of the wake-up request cannot be confirmed at step A204, the mobility computer 2 proceeds to step A205. If normal completion is confirmed before the count reaches the set time, the mobility computer 2 may proceed to step A205 without waiting for the set time to be counted.

In this case, since the ECU not supplied with power is the second end ECU 7, the mobility computer 2 instructs the first zone ECU 4 to turn ON the IPD 28 corresponding to the second end ECU 7 and starts time counting. The first zone ECU 4 turns ON the IPD 28 in response to the ON instruction from the mobility computer 2 and starts supplying power to the second end ECU 7.

When the mobility computer 2 starts time counting, it waits for the count to reach the preset set time, and when it is determined that the count has reached the set time (step A207: YES), it performs a sequence completion determination to check whether the control sequence has been completed normally (A208). Even if normal completion of the IPD ON instruction cannot be confirmed at step A207, the mobility computer 2 proceeds to step A208. If normal completion is confirmed before the count reaches the set time, the mobility computer 2 may proceed to step A208 without waiting for the set time to be counted.

Through the above processing, when performing the activation control sequence, the mobility computer 2 executes the sequence in order from the upper hierarchy, that is, in the order of the power distribution management ECU 3, the first zone ECU 4, and the end ECUs 6 and 7. That is, the mobility computer 2 starts the control sequence for the power distribution management ECU 3, and after completing the control sequence for the power distribution management ECU 3, starts the control sequence for the first zone ECU 4, and after completing the control sequence for the first zone ECU 4, starts the control sequence for the end ECUs 6 and 7.

As shown in FIG. 13, the mobility computer 2 can control three patterns of control sequences for activation. Pattern A is a pattern in which activation can be performed only by a communication frame for a wake-up request. Pattern B is a pattern involving turning ON the IPD for the end ECU. Pattern C is a pattern involving turning ON the IPD for both the zone ECU and the end ECU. For these patterns, the mobility computer 2 manages the timer as follows.

### 2-1-1 Pattern A

In FIG. 1, it is assumed that the power distribution management ECU 3, the first zone ECU 4, and the end ECUs 6 and 7 are in the following states, and the activation control processing will be described:

Power distribution management ECU 3: Constantly supplied with power, in the sleep state,

First zone ECU 4: Supplied with power, in the sleep state, and

End ECUs 6, 7: Supplied with power, in the sleep state.

The mobility computer 2 periodically transmits communication frames for wake-up requests to the first zone ECU 4, the power distribution management ECU 3, and the end ECUs 6 and 7 (A211). The mobility computer 2 sets the first timer and starts time counting with the first timer (A212). The first timer measures the elapsed time required to transition the first zone ECU 4 or the power distribution management ECU 3 from the sleep state to the wake-up state. When the mobility computer 2 determines that the set time has been counted, it sets the third timer and starts time counting with the third timer (A216). The third timer is a timer for measuring the elapsed time when transitioning the end ECUs 6 and 7 from the sleep state to the wake-up state. If the end ECUs 6 and 7 are not supplied with power, the third timer is a timer for measuring the elapsed time when activating the end ECUs 6 and 7. When the mobility computer 2 determines that the set time has been counted, it ends the control (A217).

In the above, the mobility computer 2 periodically transmits communication frames in which the corresponding bits for the first zone ECU 4, the power distribution management ECU 3, and the end ECUs 6 and 7 are set to 1 (wake-up). The first zone ECU 4 and the power distribution management ECU 3, upon receiving the communication frame for a wake-up request from the mobility computer 2, transition from the sleep state to the wake-up state. Subsequently, the first zone ECU 4, having transitioned to the wake-up state, forwards the communication frame for a wake-up request to the end ECUs 6 and 7. Then, the end ECUs 6 and 7, upon receiving the forwarded communication frame for a wake-up request from the first zone ECU 4, transition from the sleep state to the wake-up state. Note that, at the stage of setting the first timer, the mobility computer 2 periodically transmits communication frames with the corresponding bits set to "1" to the first zone ECU 4 and the power distribution management ECU 3, and at the stage of setting the third timer, it may periodically transmit communication frames with the corresponding bits set to "1" to the first zone ECU 4, the power distribution management ECU 3, and the end ECUs 6 and 7.

### 2-1-2 Pattern B

In FIG. 1, it is assumed that the power distribution management ECU 3, the first zone ECU 4, and the end ECUs 6 and 7 are in the following states, and the activation control processing will be described:

Power distribution management ECU 3: the IPD 23 is always ON and power is supplied, in the sleep state,

First zone ECU 4: Constantly supplied with power, in the sleep state, and

End ECUs 6, 7: Not supplied with power.

The mobility computer 2 periodically transmits communication frames for wake-up requests to the first zone ECU 4, the power distribution management ECU 3, and the end ECUs 6 and 7 (A211). The mobility computer 2 sets the first timer and starts time counting with the first timer (A212). When the mobility computer 2 determines that the set time has been counted, it instructs the first zone ECU 4 to turn ON the IPDs 27 and 28 corresponding to the end ECUs 6 and 7 that are not supplied with power (A215). The mobility computer 2 sets the third timer and starts time counting with the third timer (A216). When the mobility computer 2 determines that the set time has been counted, it ends the control (A217).

In the above, the mobility computer 2 periodically transmits communication frames in which the corresponding bits for the first zone ECU 4 and the power distribution management ECU 3 are set to 1 (wake-up). The first zone ECU 4 and the power distribution management ECU 3, upon receiving the communication frame for a wake-up request from the mobility computer 2, transition from the sleep state to the wake-up state. Subsequently, the first zone ECU 4, upon receiving the ON instruction for the IPDs 27 and 28 from the mobility computer 2, turns ON the IPDs 27 and 28. Then, the end ECUs 6 and 7, upon being supplied with power by the ON state of the IPDs 27 and 28 in the first zone ECU 4, are activated.

The above-described Pattern B corresponds to the flowchart explained in FIG. 12. Step A203 corresponds to the first timer in step A212, and step A206 corresponds to the third timer in step A216.

### 2-1-3 Pattern C

In FIG. 1, it is assumed that the power distribution management ECU 3, the first zone ECU 4, and the end ECUs 6 and 7 are in the following states, and the activation control processing will be described:

Power distribution management ECU 3: Constantly supplied with power, in the sleep state,

First zone ECU 4: Not supplied with power, and

End ECUs 6, 7: Not supplied with power.

The mobility computer 2 periodically transmits communication frames for wake-up requests to the first zone ECU 4, the power distribution management ECU 3, and the end ECUs 6 and 7 (A211). The mobility computer 2 sets the first timer to measure the activation of the power distribution management ECU 3 and starts time counting with the first timer (A212). When the mobility computer 2 determines that the set time has been counted, it instructs the power distribution management ECU 3 to turn ON the IPD 23 corresponding to the first zone ECU 4, which is not supplied with power (A213). The mobility computer 2 sets the second timer and starts time counting with the second timer (A214). The second timer is a timer for measuring the elapsed time when activating the first zone ECU 4. When the mobility computer 2 determines that the set time has been counted, it instructs the first zone ECU 4 to turn ON the IPDs 27 and 28 corresponding to the end ECUs 6 and 7, which are not supplied with power (A215). The mobility computer 2 sets the third timer and starts time counting with the third timer (A216). When the mobility computer 2 determines that the set time has been counted, it ends the control (A217).

In the above, the mobility computer 2 periodically transmits communication frames in which the corresponding bit for the power distribution management ECU 3 is set to 1 (wake-up). The power distribution management ECU 3, upon receiving the communication frame for a wake-up request from the mobility computer 2, transitions from the sleep state to the wake-up state. Subsequently, the power distribution management ECU 3, upon receiving the ON instruction for the IPD 23 from the mobility computer 2, turns ON the IPD 23. Then, the first zone ECU 4, which has started receiving power due to the ON state of the IPD 23 in the power distribution management ECU 3, is activated. Subsequently, the first zone ECU 4, upon receiving the ON instruction for the IPDs 27 and 28 from the mobility computer 2, turns ON the IPDs 27 and 28. Then, the end ECUs 6 and 7, which have started receiving power due to the ON state of the IPDs 27 and 28 in the first zone ECU 4, are activated.

Regarding the above-described patterns A, B, and C, the mobility computer 2 may execute these multiple control sequences simultaneously. For example, the activation sequence for the first zone ECU 4 and the end ECUs 6 and 7 may be pattern A, the activation sequence for the second zone ECU 5 and the end ECUs 8 and 9 may be pattern B, and the activation sequence for a third zone ECU and its subordinate end ECUs (not shown) may be pattern C.

The timer settings for activation control will be described. Regarding the three patterns explained in FIG. 13, for example, the first zone ECU 4 and the end ECUs 6 and 7, which are the subject of the control sequence for pattern A, are referred to as area A; the second zone ECU 5 and the end ECUs 8 and 9, which are the subject of the control sequence for pattern B, are referred to as area B; and the third zone ECU and its subordinate fifth end ECU and sixth end ECU, which are the subject of the control sequence for pattern C, are referred to as area C.

In the example shown in FIG. 13, first, second, and third timers are provided. The first timer is used in the control sequences for areas A, B, and C; the second timer is used only in the control sequence for area C; and the third timer is used in the control sequences for areas A, B, and C. The set time for the final timer, the third timer, may be set commonly for all areas or individually for each area.

When the set time for the third timer is configured to be common across all areas, the set time for the third timer is determined based on the activation time of the end ECU with the longest activation time from the start to the end of the activation process in the entire system, with an added margin. In this case, when the third timer counts up to the set time, the control is terminated. On the other hand, when the set time for the third timer is configured individually for each area, the set times for the third timer in zone A, zone B, and zone C may differ. In such cases, when executing the control sequences for areas A, B, and C simultaneously, control is not terminated even if the third timer in any area counts up to its set time; instead, the system waits until all third timers in all areas have counted up to their respective set times, and only then is control terminated.

The following describes the case where the control sequences for areas A, B, and C, that is, the control sequences of patterns A, B, and C in FIG. 13, are executed simultaneously. In FIG. 13, the mobility computer 2 periodically transmits communication frames for wake-up requests to the power distribution management ECU 3, area A, area B, and area C (A211). That is, the mobility computer 2 periodically transmits wake-up request communication frames to the power distribution management ECU 3, the first zone ECU 4, the second zone ECU 5, and the third zone ECU. The mobility computer 2 starts time counting with the first timer (A212). When the mobility computer 2 determines that the first timer has counted up to the set time, it instructs the power distribution management ECU to turn ON the IPD corresponding to the third zone ECU in area C, which is not supplied with power (A213). The mobility computer 2 starts time counting with the second timer (A214). In this case, even if the first timer has counted up to the set time in area B (pattern B), the mobility computer 2 does not start step A215, but waits for the start of step A215.

When the mobility computer 2 determines that the second timer has counted up to the set time, it instructs the second zone ECU and third zone ECU in areas B and C, respectively, to turn ON the IPDs corresponding to the end ECUs (the third end ECU 8, the fourth end ECU 9, fifth end ECU, and sixth end ECU) that are not supplied with power (A215). That is, by starting step A215 in response to the second timer counting up to the set time, step A215 in area B and step A215 in area C are started at the same timing. The mobility computer 2 starts time counting with the third timer (A216), and when it determines that the third timer has counted up to the set time, it terminates control for all of areas A, B, and C (A217).

For example, if the set time for the first timer in area B is "t1," the set time for the first timer in area C is "t2," and the set time for the second timer in area C is "t3," "t1" may be set so as to satisfy "t1 = t2 + t3." In this case, the timing at which the first timer in area B (pattern B) counts up to the set time and the timing at which the second timer in area C (pattern C) counts up to the set time will coincide, so that step A215 in area B and step A215 in area C are started at the same timing.

The following describes the case where the control sequences for areas A and B, that is, the control sequences of patterns A and B in FIG. 13, are executed simultaneously. In FIG. 13, the mobility computer 2 periodically transmits communication frames for wake-up requests to the power distribution management ECU, area A, and area B (A211). That is, the mobility computer 2 periodically transmits wake-up request communication frames to the power distribution management ECU 3, the first zone ECU 4, and the second zone ECU 5. The mobility computer 2 starts time counting with the first timer (A212). When the mobility computer 2 determines that the first timer has counted up to the set time, it instructs the second zone ECU in area B to turn ON the IPDs corresponding to the end ECUs (the third end ECU 8, the fourth end ECU 9) that are not supplied with power (A215). That is, the mobility computer 2 treats the set time of the unused second timer as "zero" and starts step A215. The mobility computer 2 starts time counting with the third timer (A216), and when it determines that the third timer has counted up to the set time, it terminates control for areas A and B (A217).

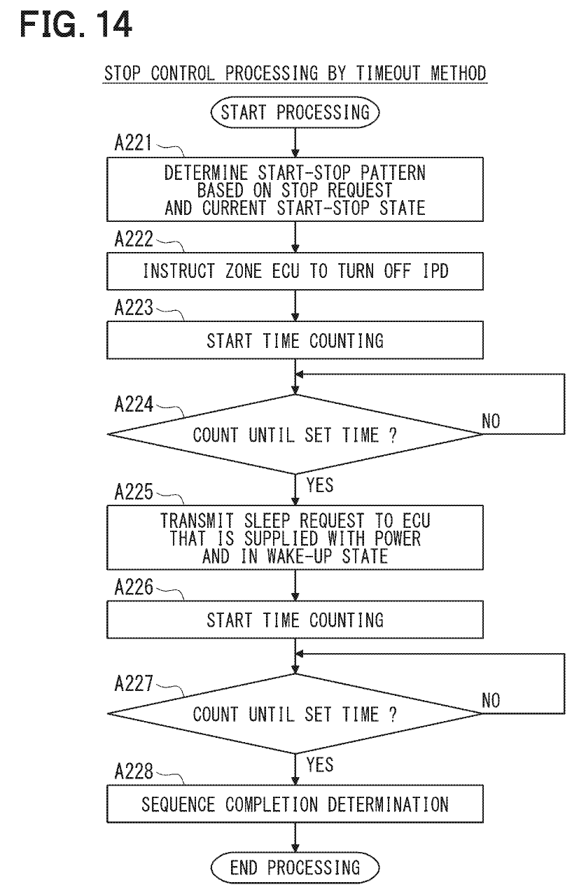

### 2-2 Stop Control Processing by Timeout Method see FIG. 14 to FIG. 15

In FIG. 1, it is assumed that the power distribution management ECU 3, the first zone ECU 4, and the end ECUs 6 and 7 are in the following states, and the stop control processing will be described:

Power distribution management ECU 3: Constantly supplied with power, in the wake-up state,

First zone ECU 4: Supplied with power, in the wake-up state,

First end ECU 6: Supplied with power, in the wake-up state, and

Second end ECU 7: Supplied with power, in the wake-up state or not supplied with power.

As shown in FIG. 14, when the mobility computer 2 receives a stop request from an application, it determines the start-stop pattern based on the received stop request and the current start-stop state (A221). That is, the mobility computer 2 determines the start-stop pattern according to FIG. 11 described above. The mobility computer 2 instructs the zone ECU to turn off the IPD corresponding to the end ECU that is supplied with power (A222), and starts time counting (A223).

In this case, since the end ECUs supplied with power are the first end ECU 6 and the second end ECU 7, the mobility computer 2 instructs the first zone ECU 4 to turn off the IPD 27 corresponding to the first end ECU 6 and the IPD 28 corresponding to the second end ECU 7, and starts time counting. The first zone ECU 4, based on the instruction from the mobility computer 2 to turn off the IPD 27 and the IPD 28, turns off the IPD 27 and the IPD 28, thereby terminating power supply to the first end ECU 6 and the second end ECU 7.

The mobility computer 2 waits for the count to reach a preset set time, and when it is determined that the count has reached the set time (step A224: YES), it transmits a communication frame for a sleep request to the ECUs that are supplied with power and are in the wake-up state (A225). Even if normal completion of the IPD OFF instruction cannot be confirmed at step A224, the mobility computer 2 proceeds to step A225. If normal completion is confirmed before the count reaches the set time, the mobility computer 2 may proceed to step A225 without waiting for the set time to be counted.

The mobility computer 2 starts time counting (A226). In this case, the mobility computer 2 transmits a communication frame for a sleep request to the first zone ECU 4 and the power distribution management ECU 3, which are supplied with power and are in the wake-up state, and starts time counting. Note that the mobility computer 2 may also transition ECUs from the wake-up state to the sleep state by stopping the periodic transmission of communication frames for wake-up requests.

The mobility computer 2 waits for the count to reach a preset set time, and when it is determined that the count has reached the set time (step A227: YES), it performs a sequence completion determination to check whether the control sequence has been completed normally (A228). Even if normal completion of the sleep request cannot be confirmed at step A227, the mobility computer 2 proceeds to step A228. If normal completion is confirmed before the count reaches the set time, the mobility computer 2 may proceed to step A228 without waiting for the set time to be counted.

Through the above processing, when performing the stop control sequence, the mobility computer 2 executes the sequence in order from the lower hierarchy, that is, in the order of end ECUs 6 and 7, first zone ECU 4, and power distribution management ECU 3. That is, the mobility computer 2 starts the control sequence for the end ECUs 6 and 7, and after completing the control sequence for the end ECUs 6 and 7, starts the control sequence for the first zone ECU 4, and after completing the control sequence for the first zone ECU 4, starts the control sequence for the power distribution management ECU 3.

As shown in FIG. 15, the mobility computer 2 can control three patterns of control sequences for stop control. Pattern D is a pattern in which stop can be performed only by a communication frame for a sleep request. Pattern E is a pattern involving turning off the IPD for the end ECU. Pattern F is a pattern involving turning off the IPD for both the end ECU and the zone ECU. For these patterns, the mobility computer 2 manages the timers as follows.

### 2-2-1 Pattern D

In FIG. 1, it is assumed that the power distribution management ECU 3, the first zone ECU 4, and the end ECUs 6 and 7 are in the following states, and the stop control processing will be described:

Power distribution management ECU 3: Constantly supplied with power, in the wake-up state,

First zone ECU 4: Supplied with power, in the wake-up state, and

End ECUs 6, 7: Supplied with power, in the wake-up state.

The mobility computer 2 periodically transmits communication frames for sleep requests to the first zone ECU 4, the power distribution management ECU 3, and the end ECUs 6 and 7 (A235). The mobility computer 2 sets the sixth timer and starts time counting with the sixth timer (A236). The sixth timer is a timer for measuring the elapsed time when transitioning the first zone ECU 4, the power distribution management ECU 3, and the end ECUs 6 and 7 from the wake-up state to the sleep state. When the mobility computer 2 determines that the set time has been counted, it terminates control (A237).

In this case, the first zone ECU 4, upon receiving the communication frame for a sleep request from the mobility computer 2, forwards the sleep request communication frame to the end ECUs 6 and 7. The end ECUs 6 and 7, upon receiving the forwarded sleep request communication frame from the first zone ECU 4, transition from the wake-up state to the sleep state. Subsequently, the first zone ECU 4 and the power distribution management ECU 3, upon receiving the communication frame for a sleep request from the mobility computer 2, transition from the wake-up state to the sleep state.

### 2-2-2 Pattern E

In FIG. 1, it is assumed that the power distribution management ECU 3, the first zone ECU 4, and the end ECUs 6 and 7 are in the following states, and the stop control processing will be described:

Power distribution management ECU 3: Constantly supplied with power, in the wake-up state,

First zone ECU 4: Constantly supplied with power, in the wake-up state, and

End ECUs 6, 7: Supplied with power, in the wake-up state.

The mobility computer 2 instructs the first zone ECU 4 to turn off the IPDs 27 and 28 corresponding to the end ECUs 6 and 7 that are supplied with power (A231). The mobility computer 2 sets the fourth timer and starts time counting with the fourth timer (A232). The fourth timer is a timer for measuring the elapsed time when stopping the end ECUs 6 and 7. When the mobility computer 2 determines that the set time has been counted, it periodically transmits communication frames for sleep requests to the first zone ECU 4 and the power distribution management ECU 3 (A235). The mobility computer 2 sets the sixth timer and starts time counting with the sixth timer (A236). When the mobility computer 2 determines that the set time has been counted, it terminates control (A237).

In this case, the first zone ECU 4, upon receiving the OFF instruction for the IPDs 27 and 28 from the mobility computer 2, turns off the IPDs 27 and 28. Subsequently, the end ECUs 6 and 7, whose power supply has been terminated by the OFF state of the IPDs 27 and 28 in the first zone ECU 4, stop operation. Subsequently, the first zone ECU 4 and the power distribution management ECU 3, upon receiving the communication frame for a sleep request from the mobility computer 2, transition from the wake-up state to the sleep state.

### 2-2-3 Pattern F

In FIG. 1, it is assumed that the power distribution management ECU 3, the first zone ECU 4, and the end ECUs 6 and 7 are in the following states, and the stop control processing will be described:

Power distribution management ECU 3: Constantly supplied with power, in the wake-up state,

First zone ECU 4: Supplied with power as needed, in the wake-up state, and

End ECUs 6, 7: Supplied with power, in the wake-up state.

The mobility computer 2 instructs the first zone ECU 4 to turn off the IPDs 27 and 28 corresponding to the end ECUs 6 and 7 that are supplied with power (A231). The mobility computer 2 sets the fourth timer and starts time counting with the fourth timer (A232). When the mobility computer 2 determines that the set time has been counted, it instructs the power distribution management ECU 3 to turn off the IPD 23 corresponding to the first zone ECU 4 that is supplied with power (A233). The mobility computer 2 sets the fifth timer and starts time counting with the fifth timer (A234). The fifth timer is a timer for measuring the elapsed time when stopping the first zone ECU 4. When the mobility computer 2 determines that the set time has been counted, it periodically transmits communication frames for sleep requests to the power distribution management ECU 3 (A235). The mobility computer 2 sets the sixth timer and starts time counting with the sixth timer (A236). When the mobility computer 2 determines that the set time has been counted, it terminates control (A237).

In this case, the first zone ECU 4, upon receiving the OFF instruction for the IPDs 27 and 28 from the mobility computer 2, turns off the IPDs 27 and 28. Subsequently, the end ECUs 6 and 7, whose power supply has been terminated by the OFF state of the IPDs 27 and 28 in the first zone ECU 4, stop operation. Next, the power distribution management ECU 3, upon receiving the OFF instruction for the IPD 23 from the mobility computer 2, turns off the

IPD 23. Subsequently, the first zone ECU 4, whose power supply has been terminated by the OFF state of the IPD 23 in the power distribution management ECU 3, stops operation. Finally, the power distribution management ECU 3, upon receiving the communication frame for a sleep request from the mobility computer 2, transitions from the wake-up state to the sleep state.

Regarding the above-described patterns D, E, and F, the mobility computer 2 may execute these multiple stop control sequences simultaneously. For example, the stop sequence for the first zone ECU 4 and the end ECUs 6 and 7 may be pattern D, the stop sequence for the second zone ECU 5 and the end ECUs 8 and 9 may be pattern E, and the stop sequence for a third zone ECU and its subordinate end ECUs (not shown) may be pattern F.

The timer settings for stop control will be described. Regarding the three patterns explained in FIG. 15, for example, the first zone ECU 4 and the end ECUs 6 and 7, which are the subject of the control sequence for pattern D, are referred to as area D; the second zone ECU 5 and the end ECUs 8 and 9, which are the subject of the control sequence for pattern E, are referred to as area E; and the third zone ECU and its subordinate fifth end ECU and sixth end ECU, which are the subject of the control sequence for pattern F, are referred to as area F.

In the example shown in FIG. 15, fourth, fifth, and sixth timers are provided. The fourth timer is used in the control sequences for areas E and F; the fifth timer is used only in the control sequence for area F; and the sixth timer is used in the control sequences for areas D, E, and F. The set time for the final timer, the sixth timer, may be set commonly for all areas or individually for each area. That is, the sixth timer may be set as a common timer for all stop sequences, or individual sixth timers may be set for each pattern.

When the set time for the sixth timer is configured to be common across all areas, the set time for the sixth timer is determined based on the stop time of the ECU with the longest stop time from the start to the end of the stop process in the entire system, with an added margin. In this case, when the sixth timer counts up to the set time, the control is terminated. On the other hand, when the set time for the sixth timer is configured individually for each area, the set times for the sixth timer in area D, area E, and area F may differ. In such cases, control is not terminated even if the sixth timer in any area counts up to its set time; instead, the system waits until all sixth timers in all areas have counted up to their respective set times, and only then is control terminated for all areas.

The following describes the case where the control sequences for stop control in areas D, E, and F, that is, the control sequences of patterns D, E, and F in FIG. 15, are executed simultaneously. In FIG. 15, the mobility computer 2 instructs the zone ECU to turn off the IPDs corresponding to the end ECUs supplied with power in areas E and F (A231). The first zone ECU 4 turns off the IPDs, thereby cutting off power supply to the first end ECU 6 and the second end ECU 7. The second zone ECU 5 turns off the IPDs, thereby cutting off power supply to the third end ECU 8 and the fourth end ECU 9. The third zone ECU turns off the IPDs, thereby cutting off power supply to the fifth end ECU and the sixth end ECU. The mobility computer 2 starts time counting with the fourth timer (A232). When the mobility computer 2 determines that the fourth timer has counted up to the set time, it instructs the power distribution management ECU to turn off the IPD corresponding to the zone ECU supplied with power in area F (A233). The power distribution management ECU 3 turns off the IPD, thereby cutting off power supply to the third zone ECU. The mobility computer 2 starts time counting with the fifth timer (A234). In this case, even if the mobility computer 2 determines that the fourth timer has counted up to the set time, it does not start step A235 in area E, but waits for the start of step A235.

When the mobility computer 2 determines that the fifth timer has counted up to the set time, it periodically transmits communication frames for sleep requests to areas D, E, and F (A235). That is, by starting step A235 in response to the fifth timer counting up to the set time, step A235 in area E and step A235 in area F are started at the same timing. The first zone ECU 4, the second zone ECU 5, and the power distribution management ECU 3, upon receiving the communication frames, transition to the sleep state. The mobility computer 2 starts time counting with the sixth timer (A236), and when it determines that the sixth timer has counted up to the set time, it terminates control for all of areas D, E, and F (A237).

For example, if the set time for the fourth timer in area E is "t4," the set time for the fourth timer in area F is "t5," and the set time for the fifth timer in area F is "t6," "t4" may be set so as to satisfy "t4 = t5 + t6." In this case, the timing at which the fourth timer in area E counts up to the set time and the timing at which the fifth timer in area F counts up to the set time will coincide, so that step A235 in area E and step A235 in area F are started at the same timing.

Note that, among the zone ECUs and end ECUs for which power distribution is to be stopped, for example, in the chassis system or powertrain system, it is necessary to perform termination processing such as learning processing before stopping power distribution. Therefore, ECUs in the chassis system or powertrain system perform stop processing after executing a handshake process. The handshake process refers to a process in which, between the ECU instructing power cutoff and the ECU subject to power cutoff, actual power cutoff is performed only after the termination processing of the ECU subject to power cutoff is completed. For example, when performing a handshake process between a zone ECU and an end ECU, the zone ECU transmits a power cutoff notification to the end ECU before turning off the IPD, thereby initiating termination processing such as learning processing. The end ECU, upon receiving the power cutoff notification from the zone ECU, transmits an acknowledgment response to the zone ECU specifying a predetermined time required for termination processing such as learning processing. The zone ECU, upon receiving the acknowledgment response from the end ECU, sets a timer to measure a period longer than the predetermined time specified in the acknowledgment response, and when it is determined that the set time has been counted, turns off the IPD that controls power supply to the end ECU.

In this case, if the design includes a timeout and forced stop function for termination processing, a timer is set for each zone ECU or end ECU that requires a handshake process. In addition, a forced timer is provided so that a timeout occurs if there is no response to a power control request. Furthermore, the zone ECUs or end ECUs that are ready to stop will be stopped sequentially. Therefore, a timeout function is provided for each zone for power control completion, and for each zone ECU or end ECU corresponding to the handshake process.

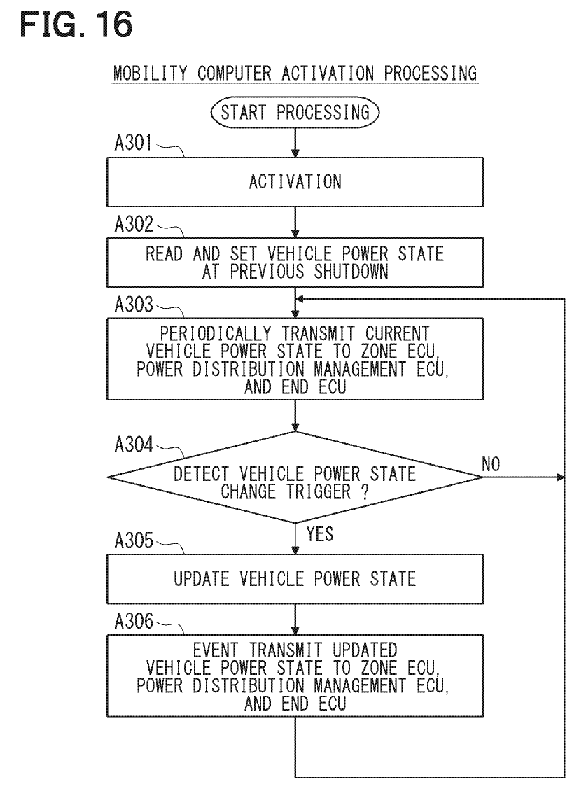

### 3 Management of Vehicle Power State see FIG. 16 to FIG. 20

In the management of the vehicle power state, which indicates the overall power state of the vehicle, the power distribution management ECU 3, the first zone ECU 4, and the end ECUs 6 and 7 set their own vehicle power state to undefined at startup, and maintain this undefined setting until the latest vehicle power state information is obtained from the mobility computer 2. The vehicle power state is synonymous with the scenes described in FIG. 6 and FIG. 11 above. That is, the parked scene is synonymous with the vehicle power state "parked," the occupied scene is synonymous with the vehicle power state "occupied," and the driving scene is synonymous with the vehicle power state "driving." When the mobility computer 2 determines the vehicle power state information, it transmits the determined vehicle power state information to the first zone ECU 4. When the first zone ECU 4 receives the vehicle power state information from the mobility computer 2, it transmits the received vehicle power state information to the end ECUs 6 and 7.

When the power distribution management ECU 3, the first zone ECU 4, and the end ECUs 6 and 7 are set to undefined, only minimum functions such as communication reception are operated, and communication interruption diagnostics are masked, so that even if an abnormality is diagnosed by the diagnostic function, it is ignored. That is, even if the power distribution management ECU 3, the first zone ECU 4, and the end ECUs 6 and 7 stop receiving communication frames from their communication partners and determine that a communication interruption has occurred, it is not regarded as an abnormality. Furthermore, even if a communication interruption is determined to have occurred, it is acceptable not to store the communication interruption diagnostic.

When the power distribution management ECU 3, the first zone ECU 4, and the end ECUs 6 and 7 obtain the latest power state information from the mobility computer 2, and the obtained power state information indicates a state transition, they set the vehicle-wide power state they hold to "in state transition" and update it during the state transition. When set to "in state transition," the power distribution management ECU 3, the first zone ECU 4, and the end ECUs 6 and 7 mask communication interruption diagnostics and ignore any abnormalities diagnosed by the diagnostic function. The same applies to the second zone ECU 5 and the end ECUs 8 and 9.

### 3-1 Activation Processing of Mobility computer 2 referring to FIG. 16

As shown in FIG. 16, when the mobility computer 2 is activated (A301), it reads and sets the vehicle power state saved in memory at the previous shutdown (A302). The mobility computer 2 periodically transmits the current vehicle power state to the zone ECU, power distribution management ECU, and end ECU (A303). The vehicle power state transmitted from the mobility computer 2 is relayed by the zone ECU, so that the vehicle power state is also periodically transmitted to the end ECUs. The mobility computer 2 determines whether a vehicle power state change trigger indicating a change in the vehicle power state has been detected, for example, by the operation of an application (A304). If it is determined that a vehicle power state change trigger has not been detected (A304: NO), the process returns to step A303 and repeats the periodic transmission of the current vehicle power state.

If the mobility computer 2 determines that a vehicle power state change trigger has been detected (A304: YES), it updates the vehicle power state (A305), transmits the updated vehicle power state as the latest vehicle power state to the zone ECU, power distribution management ECU, and end ECU by event transmission (A306), and then returns to step A303 to repeat the process from step A303 onward.

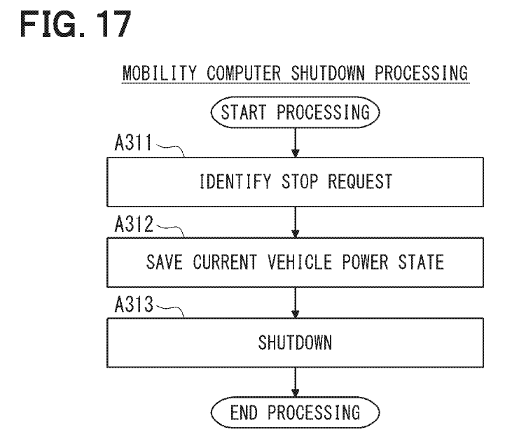

### 3-2 Shutdown Processing of Mobility computer 2 referring to FIG. 17

As shown in FIG. 17, when the mobility computer 2 identifies a stop request (A311), it saves the current vehicle power state to memory (A312) and then shuts down (A313).

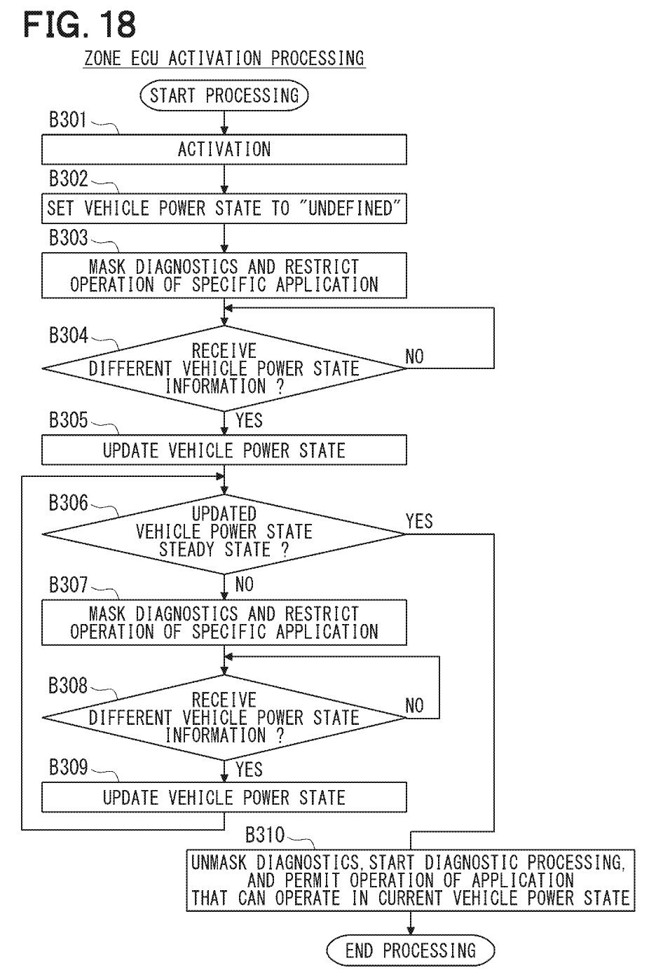

### 3-3 Activation Processing of First Zone ECU 4 see FIG. 18

The following describes the activation processing for the first zone ECU 4, representative of the power distribution management ECU 3 and the end ECUs 6 and 7. As shown in FIG. 18, when the first zone ECU 4 receives an NM message and is activated (B301), it sets the vehicle power state to "undefined" (B302), masks diagnostics, and restricts the operation of specific applications (B303). The first zone ECU 4 determines whether it has received vehicle power state information indicating a vehicle power state different from the current vehicle power state (B304). If it is determined that vehicle power state information indicating a vehicle power state different from the current vehicle power state has not been received (B304: NO), it continues to mask diagnostics and restrict the operation of specific applications.

If the first zone ECU 4 determines that it has received vehicle power state information indicating a vehicle power state different from the current vehicle power state (B304: YES), it updates the vehicle power state (B305) and determines whether the updated vehicle power state is a steady state (B306). If it is determined that the updated vehicle power state is not a steady state, i.e., is in a state transition (B306: NO), it sets its held vehicle power state to "in state transition," continues to mask diagnostics, and restricts the operation of specific applications (B307).

The first zone ECU 4 determines whether it has received vehicle power state information indicating a vehicle power state different from the current vehicle power state (B308). If it is determined that vehicle power state information indicating a vehicle power state different from the current vehicle power state has not been received (B308: NO), it continues to mask diagnostics and restrict the operation of specific applications.

If the first zone ECU 4 determines that it has received vehicle power state information indicating a vehicle power state different from the current vehicle power state (B308: YES), it updates the vehicle power state based on the received vehicle power state information (B309), returns to step B306, and repeats the process from step B306 onward.

If the first zone ECU 4 determines that the updated vehicle power state is a steady state (B306: YES), it unmasks diagnostics and starts diagnostic processing, and permits the operation of applications that can operate in the current vehicle power state (B310).

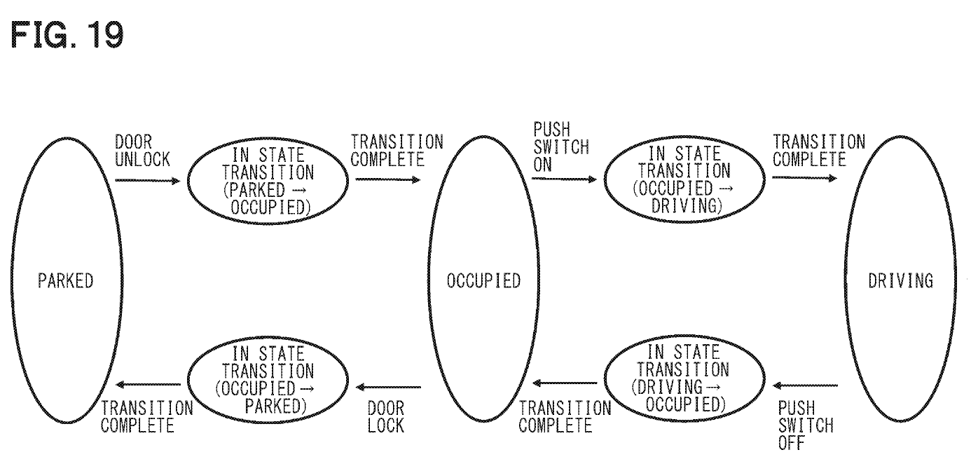

FIG. 19 shows the state transitions in the mobility computer 2. The mobility computer 2 transitions the vehicle power state according to the scene. When the mobility computer 2 detects a door unlock in the "parked" state, it transitions to "in transition from parked to occupied," and upon completion of the state transition, transitions to "occupied." When the mobility computer 2 detects a push switch ON in the "occupied" state, it transitions to "in transition from occupied to driving," and upon completion of the state transition, transitions to "driving." When the mobility computer 2 detects a push switch OFF in the "driving" state, it transitions to "in transition from driving to occupied," and upon completion of the state transition, transitions to "occupied." When the mobility computer 2 detects a door lock in the "occupied" state, it transitions to "in transition from occupied to parked," and upon completion of the state transition, transitions to "parked."

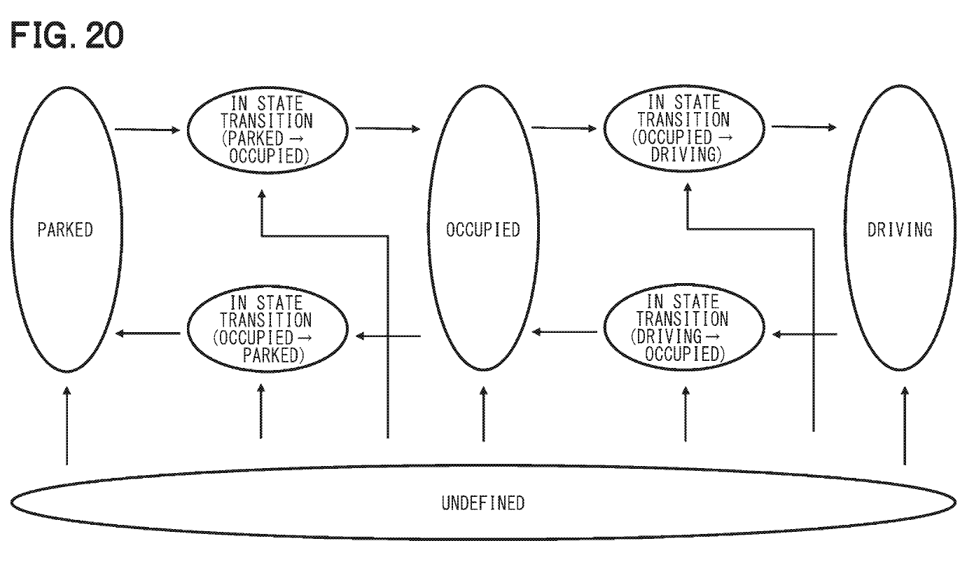

FIG. 20 shows the state transitions of the first zone ECU 4, the power distribution management ECU 3, and the end ECUs 6 and 7. The first zone ECU 4, the power distribution management ECU 3, and the end ECUs 6 and 7 each transition their state based on the vehicle power state information received from the mobility computer 2.

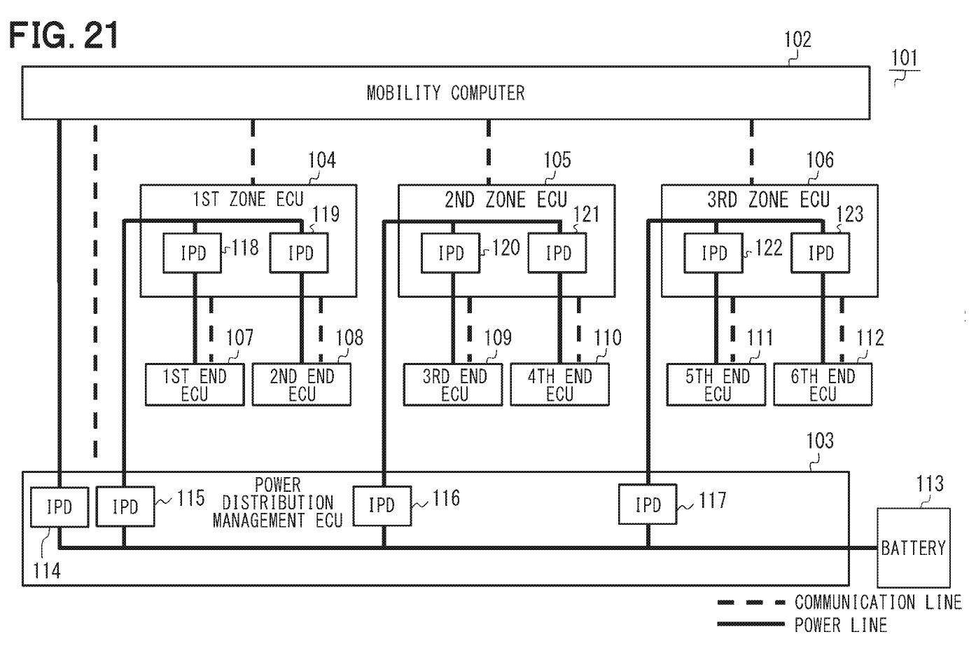

The communication system 1 described above forms various network configurations. The network configurations will be described below with reference to FIG. 21 through FIG. 25. In all of the network configurations described below, the start-stop control based on the aforementioned scenes, the start-stop control by the timeout method, and management of the vehicle power state are performed.

### 1 Star-type Connection Configuration with Separated Power Distribution Management ECU and Zone ECU see FIG. 21

A communication system 101 includes a mobility computer 102 (corresponding to the management device), a power distribution management ECU 103 (corresponding to the power distribution management device), the zone ECUs 104 to 106 (electronic control units, corresponding to the first electronic control unit), and the end ECUs 107 to 112 (electronic control units, corresponding to the second electronic control unit). The mobility computer 102 is communicably connected to the power distribution management ECU 103, the first zone ECU 104, the second zone ECU 105, and the third zone ECU 106. The first zone ECU 104 is communicably connected to the first end ECU 107 and the second end ECU 108. The second zone ECU 105 is communicably connected to the third end ECU 109 and the fourth end ECU 110. The third zone ECU 106 is communicably connected to the fifth end ECU 111 and the sixth end ECU 112.

The power distribution management ECU 103 distributes electric power supplied from the battery 113 to the mobility computer 102, the zone ECUs 104 to 106, and the end ECUs 107 to 112. The power distribution management ECU 103 supplies constant power to the mobility computer 102 by keeping the IPD 114 always ON. The power distribution management ECU 103 manages power distribution to the first zone ECU 104 by turning the IPD 115 ON/OFF, manages power distribution to the second zone ECU 105 by turning the IPD 116 ON/OFF, and manages power distribution to the third zone ECU 106 by turning the IPD 117 ON/OFF.

The first zone ECU 104 manages power distribution to the first end ECU 107 by turning the IPD 118 ON/OFF, and manages power distribution to the second end ECU 108 by turning the IPD 119 ON/OFF. The second zone ECU 105 manages power distribution to the third end ECU 109 by turning the IPD 120 ON/OFF, and manages power distribution to the fourth end ECU 110 by turning the IPD 121 ON/OFF. The third zone ECU 106 manages power distribution to the fifth end ECU 111 by turning the IPD 122 ON/OFF, and manages power distribution to the sixth end ECU 112 by turning the IPD 123 ON/OFF.

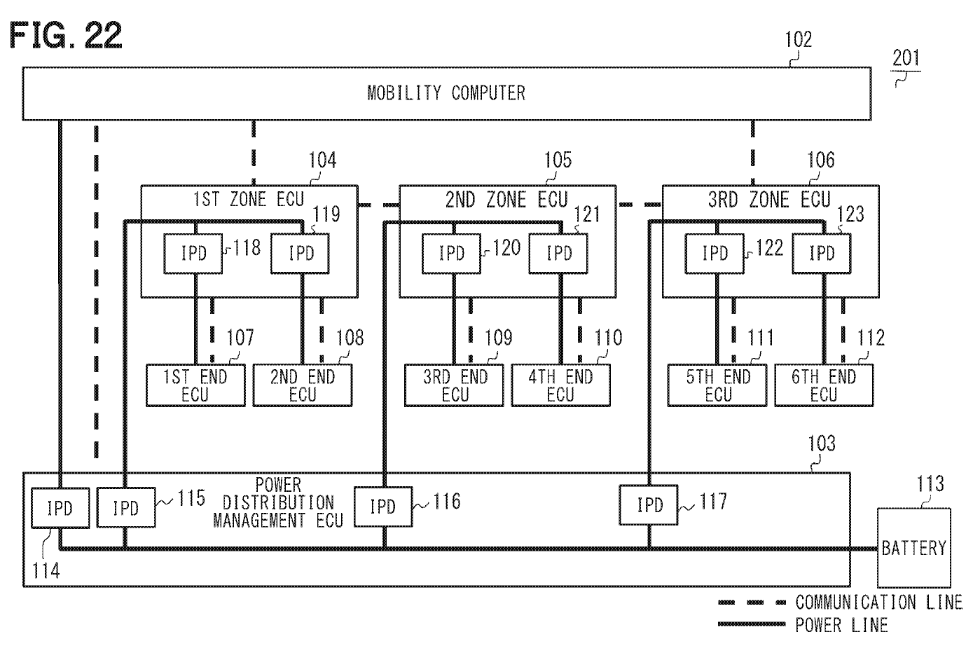

### 2 Ring-type Connection Configuration with Separated Power Distribution Management ECU and Zone ECU see FIG. 22

Communication system 201 differs from communication system 101 described in FIG. 21 in that the mobility computer 102 and zone ECUs 104 to 106 are communicably connected in a ring configuration. The mobility computer 102 communicates with the second zone ECU 105 via either the first zone ECU 104 or the third zone ECU 106. That is, data transmitted from the mobility computer 102 to the first zone ECU 104 is forwarded from the first zone ECU 104 to the second zone ECU 105. Similarly, data transmitted from the mobility computer 102 to the third zone ECU 106 is forwarded from the third zone ECU 106 to the second zone ECU 105.

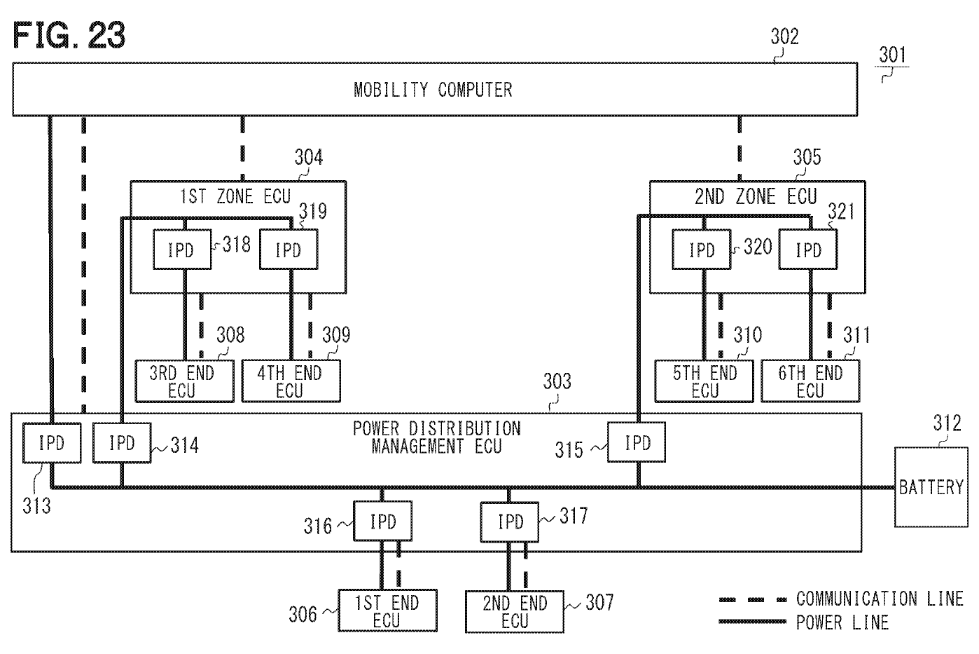

### 3 Star-type Connection Configuration with Integrated Power Distribution Management ECU and Zone ECU see FIG. 23

Communication system 301 comprises a mobility computer 302 (corresponding to the management device), a power distribution management ECU 303 (corresponding to the power distribution management device), the zone ECUs 304 and 305 (electronic control units, corresponding to the first electronic control unit), the end ECUs 306 and 307 (electronic control units, also corresponding to the first electronic control unit), and the end ECUs 308 to 311 (electronic control units, corresponding to the second electronic control unit). The power distribution management ECU 303 has a function as a zone ECU positioned above some of the end ECUs. The mobility computer 302 is communicably connected to the power distribution management ECU 303, the first zone ECU 304, and the second zone ECU 305. The power distribution management ECU 303 is communicably connected to the first end ECU 306 and the second end ECU 307. The first zone ECU 304 is communicably connected to the third end ECU 308 and the fourth end ECU 309. The second zone ECU 305 is communicably connected to the fifth end ECU 310 and the sixth end ECU 311.

The power distribution management ECU 303 distributes electric power supplied from the battery 312 to the mobility computer 302, zone ECUs 304 and 305, and end ECUs 306 and 307. The power distribution management ECU 303 supplies constant power to the mobility computer 302 by keeping the IPD 313 ON at all times. The power distribution management ECU 303 manages power distribution to the first zone ECU 304 by turning the IPD 314 ON/OFF, manages power distribution to the second zone ECU 305 by turning the IPD 315 ON/OFF, manages power distribution to the first end ECU 306 by turning the IPD 316 ON/OFF, and manages power distribution to the second end ECU 307 by turning the IPD 317 ON/OFF.

The first zone ECU 304 manages power distribution to the third end ECU 308 by turning the IPD 318 ON/OFF, and manages power distribution to the fourth end ECU 309 by turning the IPD 319 ON/OFF. The second zone ECU 305 manages power distribution to the fifth end ECU 310 by turning the IPD 320 ON/OFF, and manages power distribution to the sixth end ECU 311 by turning the IPD 321 ON/OFF.

In the configuration where end ECUs 306 and 307 are directly connected to the power distribution management ECU 303, and the power distribution management ECU 303 functions as a zone ECU positioned above some of the end ECUs, the mobility computer 302 outputs IPD ON signals and IPD OFF signals for the IPD 316 corresponding to the first end ECU 306 and the IPD 317 corresponding to the second end ECU 307 directly to the power distribution management ECU 303. The power distribution management ECU 303 turns the IPD 316 ON/OFF based on the ON/OFF instruction for the IPD 316 from the mobility computer 302, thereby switching between the power supply state and the power cutoff state for the first end ECU 306. The power distribution management ECU 303 turns the IPD 317 ON/OFF based on the ON/OFF instruction for the IPD 317 from the mobility computer 302, thereby switching between the power supply state and the power cutoff state for the second end ECU 307. Note that, while FIG. 23 illustrates a configuration in which only some of the end ECUs 306 and 307 are directly connected to the power distribution management ECU 303, it is also possible to have a configuration in which all end ECUs 306 to 311 are directly connected to the power distribution management ECU 303, or a configuration in which the zone ECUs 304 and 305 are omitted. In such cases, the IPDs 314 and 315 are omitted, and the IPDs corresponding to the IPDs 318 to 321 are provided in the power distribution management ECU 303.

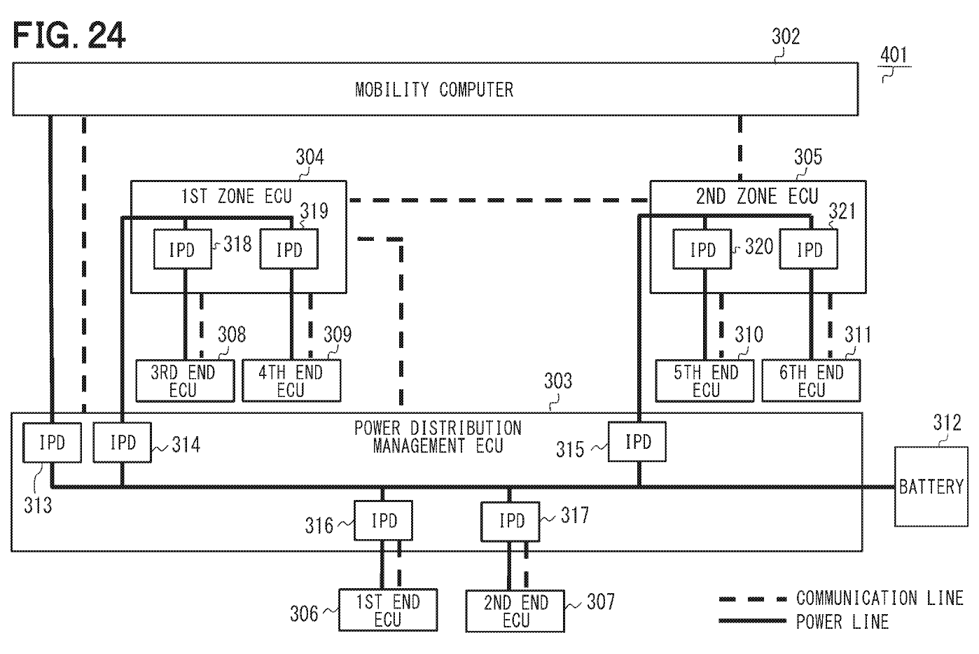

### 4 Ring-type Connection Configuration with Integrated Power Distribution Management ECU and Zone ECU see FIG. 24

Communication system 401 differs from communication system 301 described in FIG. 23 in that the mobility computer 302, the power distribution management ECU 303, and the zone ECUs 304 and 305 are communicably connected in a ring configuration. The mobility computer 302 communicates with the first zone ECU 304 via either the power distribution management ECU 303 or the second zone ECU 305. That is, data transmitted from the mobility computer 302 to the power distribution management ECU 303 is forwarded from the power distribution management ECU 303 to the first zone ECU 304. Similarly, data transmitted from the mobility computer 302 to the second zone ECU 305 is forwarded from the second zone ECU 305 to the first zone ECU 304. As in FIG. 23, the power distribution management ECU 303 turns the IPD 316 ON/OFF based on the ON/OFF instruction for the IPD 316 from the mobility computer 302, thereby switching between the power supply state and power cutoff state for the first end ECU 306. The power distribution management ECU 303 also turns the IPD 317 ON/OFF based on the ON/OFF instruction for the IPD 317 from the mobility computer 302, thereby switching between the power supply state and power cutoff state for the second end ECU 307.

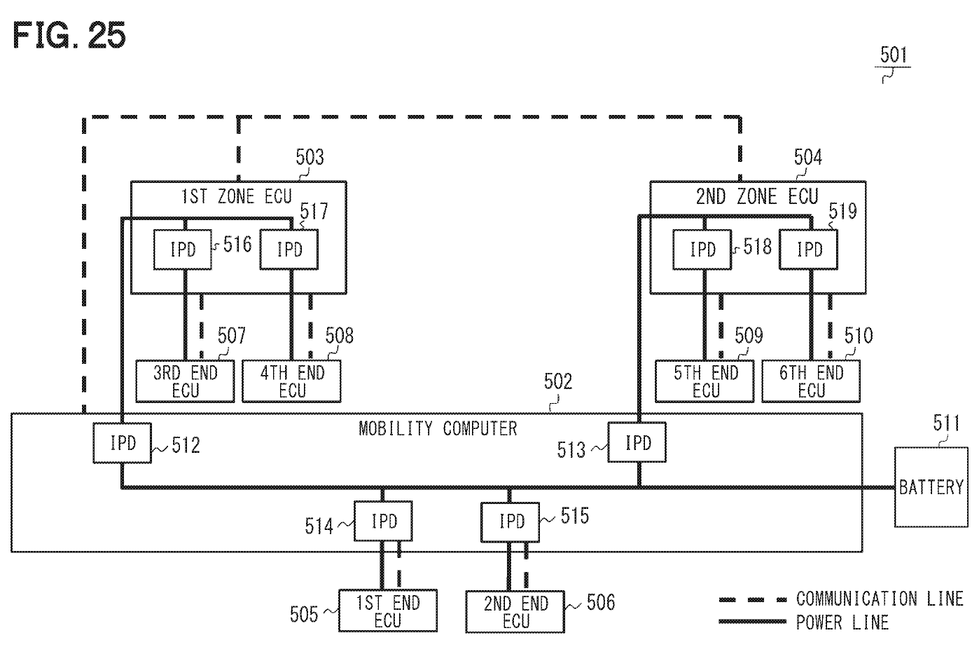

### 5 Connection Configuration with Integrated Mobility computer, Power Distribution Management ECU, and Zone ECU referring to FIG. 25

A communication system 501 includes a mobility computer 502 (corresponding to the management device), the zone ECUs 503 and 504 (electronic control units, corresponding to the first electronic control unit), the end ECUs 505 and 506 (electronic control units, also corresponding to the first electronic control unit), and the end ECUs 507 to 510 (electronic control units, corresponding to the second electronic control unit). The mobility computer 502 has both the function of a power distribution management ECU and the function of a zone ECU positioned above some of the end ECUs. The mobility computer 502 is communicably connected to the first zone ECU 503, the second zone ECU 504, the first end ECU 505, and the second end ECU 506. The first zone ECU 503 is communicably connected to the third end ECU 507 and the fourth end ECU 508. The second zone ECU 504 is communicably connected to the fifth end ECU 509 and the sixth end ECU 510.

The mobility computer 502 is directly connected to the battery 511 and distributes electric power supplied from the battery 511 to the zone ECUs 503 and 504 and end ECUs 505 and 506. The mobility computer 502 manages power distribution to the first zone ECU 503 by turning the IPD 512 ON/OFF, manages power distribution to the second zone ECU 504 by turning the IPD 513 ON/OFF, manages power distribution to the first end ECU 505 by turning the IPD 514 ON/OFF, and manages power distribution to the second end ECU 506 by turning the IPD 515 ON/OFF.

The first zone ECU 503 manages power distribution to the third end ECU 507 by turning the IPD 516 ON/OFF, and manages power distribution to the fourth end ECU 508 by turning the IPD 517 ON/OFF. The second zone ECU 504 manages power distribution to the fifth end ECU 509 by turning the IPD 518 ON/OFF, and manages power distribution to the sixth end ECU 510 by turning the IPD 519 ON/OFF.

In the configuration where the mobility computer 502 is directly connected to the battery 511 and the end ECUs 505 and 506 are directly connected to the mobility computer 502, with the mobility computer 502 having both the function of a power distribution management ECU and a zone ECU, the mobility computer 502 itself manages power distribution to the zone ECUs 503 and 504 and the end ECUs 505 and 506. The mobility computer 502 turns the IPD 512 ON/OFF to switch between the power supply state and power cutoff state for the first zone ECU 503. The mobility computer 502 turns the IPD 513 ON/OFF to switch between the power supply state and power cutoff state for the second zone ECU 504. The mobility computer 502 turns the IPD 514 ON/OFF to switch between the power supply state and power cutoff state for the first end ECU 505. The mobility computer 502 turns the IPD 515 ON/OFF to switch between the power supply state and power cutoff state for the second end ECU 506. Note that, while FIG. 25 illustrates a configuration in which only some of the end ECUs 505 and 506 are directly connected to the mobility computer 502, it is also possible to have a configuration in which all end ECUs 505 to 510 are directly connected to the mobility computer 502, or a configuration in which the zone ECUs 503 and 504 are omitted. In such cases, the IPDs 512 and 513 are omitted, and the IPDs corresponding to the IPDs 516 to 519 are provided in the mobility computer 502.

As described above, according to the present embodiment, the following effects can be obtained. In the communication system 1, when managing the vehicle scene and receiving a request for activation or stop for the target ECUs 3 to 9, whether to perform the start-stop control via relays or to perform the start-stop control based on communication frames is determined according to the destination scene. By determining, based on the destination scene, whether to perform the start-stop control via relays and whether to perform the start-stop control based on communication frames, it is possible to appropriately perform power control at the ECU unit level while avoiding increased control complexity.

Whether the source scene and the destination scene are the same is determined, and based on the result of this determination, whether to perform the start-stop control via relays and whether to perform the start-stop control based on communication frames is decided. When transitioning from the current scene to a different scene, it is possible to appropriately perform power control at the ECU unit level.

Whether the destination scene is a specific scene is determined, and based on the result of this determination, whether to perform the start-stop control via relays and whether to perform the start-stop control based on communication frames is decided. When transitioning to a specific scene, it is possible to appropriately perform power control at the ECU unit level.

A management table is maintained that specifies, for each scene, the ECUs to be externally supplied with power. Based on the management table, whether to perform the start-stop control via relays and whether to perform the start-stop control based on communication frames is decided. By preparing a management table, it is possible to appropriately perform power control at the ECU unit level.

The present disclosure has been described in accordance with embodiments, but it is understood that the present disclosure is not limited to the embodiments or structures described. The present disclosure also encompasses various modifications and equivalents. In addition, various combinations and forms, as well as other combinations and forms including only one element, more than one, or fewer than one, are also within the scope and spirit of the present disclosure.

The control unit and its methods described in the present disclosure may be implemented by a dedicated computer provided by configuring a processor and memory programmed to execute one or more functions as a computer program. Alternatively, the control unit and its methods described in the present disclosure may be implemented by a dedicated computer provided by configuring a processor with one or more dedicated hardware logic circuits. Alternatively, the control unit and its methods described in the present disclosure may be implemented by one or more dedicated computers configured by a combination of a processor and memory programmed to execute one or more functions and a processor configured with one or more hardware logic circuits. Furthermore, the computer program may be stored as instructions to be executed by a computer on a computer-readable non-transitory tangible recording medium.

What is claimed is:

1. A communication system mounted on a mobile body, the communication system comprising:
a management device; and
an electronic control unit arranged to be capable of communication with the management device,
wherein
the electronic control unit is configured to be activated by power supplied externally via a relay and stopped by power cutoff externally via the relay, and is further configured to, in a state in which power is supplied, perform activation by switching to a wake-up state and stop by switching to a sleep state, based on a communication frame received externally; and
the management device is configured to manage a scene relating to a behavior of the mobile body, and determine, when a request for activation or stop is received for the electronic control unit, based on the scene, whether to perform a first start-stop control for the electronic control unit via the relay, and determine whether to perform a second start-stop control for the electronic control unit by switching to the wake-up state or the sleep state.

2. The communication system according to claim 1, wherein
the scene includes a vehicle state or function; and
based on the vehicle state or the function, the management device determines whether to perform the first start-stop control and determines whether to perform the second start-stop control.

3. The communication system according to claim 1, wherein
based on whether a source scene and a destination scene are identical, the management device determines whether to perform the first start-stop control and determines whether to perform the second start-stop control.

4. The communication system according to claim 3, wherein
when the source scene and the destination scene are identical, the management device determines not to perform the first start-stop control and determines to perform the second start-stop control, and
when the source scene and the destination scene are different, the management device determines to perform both the first start-stop control and the second start-stop control.

5. The communication system according to claim 3, wherein
based on whether the destination scene is a specific scene, the management device determines whether to perform the first start-stop control and determines whether to perform the second start-stop control.

6. The communication system according to claim 5, wherein
when the destination scene is the specific scene, the management device determines to perform the first start-stop control and not to perform the second start-stop control.

7. The communication system according to claim 1, wherein
the management device includes a management table specifying, for each scene, the electronic control unit to be externally supplied with power, and
the management device, based on the management table, determines whether to perform the first start-stop control and determines whether to perform the second start-stop control.

8. The communication system according to claim 7, wherein
the management device, when transitioning from one scene to another scene, based on the management table, performs a start control via the relay for the electronic control unit defined to be supplied with power, and performs a stop control via the relay for the electronic control unit defined not to be supplied with power.

9. The communication system according to claim 7, wherein
the management device, when it is determined, based on the management table, that power supply to an electronic control unit being supplied with power is unnecessary, performs a stop control via the relay for the electronic control unit, or transitions the electronic control unit from the wake-up state to the sleep state.

10. The communication system according to claim 1, wherein
the electronic control unit includes:
a first electronic control unit arranged to be capable of direct communication with the management device; and
a second electronic control unit arranged to be capable of communication with the management device via the first electronic control unit,
the communication system further comprises a power distribution management device that is arranged to be capable of direct communication with the management device and manages power distribution to the first electronic control unit and the second electronic control unit.

11. The communication system according to claim 1, wherein
the electronic control unit includes:
a first electronic control unit arranged to be capable of direct communication with the management device; and
a second electronic control unit arranged to be capable of communication with the management device via the first electronic control unit, and
the management device manages power distribution to the first electronic control unit and the second electronic control unit.

12. A management device arranged to be capable of communication with an electronic control unit, within a communication system mounted on a mobile body, the electronic control unit being configured to be activated by power supplied externally via a relay and stopped by power cutoff externally via the relay, and further configured to, in a state in which power is supplied, perform activation by switching to a wake-up state and stop by switching to a sleep state based on a communication frame received externally, the management device comprising
at least one of (i) a circuit and (ii) a processor with a memory storing computer program code executable by the processor,
wherein
the at least one of the circuit and the processor is configured to manage a scene relating to a behavior of the mobile body, and
when a request for activation or stop is received for the electronic control unit, the at least one of the circuit and the processor is configured to determine, based on the scene, whether to perform a first start-stop control for the electronic control unit via the relay, and whether to perform a second start-stop control for the electronic control unit by switching to the wake-up state or the sleep state.

13. A method for a start-stop control of an electronic control unit in a communication system including a management device and an electronic control unit arranged to be capable of communication with the management device, the electronic control unit being configured to be activated by power supplied externally via a relay and stopped by power cutoff externally via the relay, and further configured to, in a state in which power is supplied, perform activation by switching to a wake-up state and stop by switching to a sleep state based on a communication frame received externally, the communication system being mounted on a mobile body, the method comprising:
a first procedure of managing a scene relating to a behavior of the mobile body and receiving a request for activation or stop of the electronic control unit; and
a second procedure of determining, based on the scene, whether to perform a first start-stop control for the electronic control unit via the relay, and determining whether to perform a second start-stop control for the electronic control unit by switching to the wake-up state or the sleep state.

14. A non-transitory computer readable storage medium storing a start-stop control program for an electronic control unit, the program being executed by a control unit of a management device arranged to be capable of communication with an electronic control unit mounted on a mobile body, the electronic control unit being configured to be activated by power supplied externally via a relay and stopped by power cutoff externally via the relay, and further configured to, in a state in which power is supplied, perform activation by switching to a wake-up state and stop by switching to a sleep state based on a communication frame received externally,
the program causing the control unit to execute:
a first procedure of managing a scene relating to a behavior of the mobile body and receiving a request for activation or stop of the electronic control unit; and
a second procedure of determining, based on the scene, whether to perform a first start-stop control for the electronic control unit via the relay, and determining whether to perform a second start-stop control for the electronic control unit by switching to the wake-up state or the sleep state.
